(19) United States
(12) Patent Application Publication
(10) Pub. No.: US 2025/0063125 A1
(43) Pub. Date: Feb. 20, 2025

(54) STORAGE MEDIUM STORING PROGRAM, CONTROL METHOD, AND INFORMATION PROCESSING APPARATUS

(71) Applicant: CANON KABUSHIKI KAISHA, Tokyo (JP)

(72) Inventor: KIMIMORI EGUCHI, Chiba (JP)

(21) Appl. No.: 18/795,304

(22) Filed: Aug. 6, 2024

(30) Foreign Application Priority Data
Aug. 14, 2023 (JP) 2023-132028

(51) Int. Cl. H04N 1/00; G06F 3/12

(52) U.S. Cl. CPC H04N 1/00883; G06F 3/1205; G06F 3/1232

(57) ABSTRACT

A non-transitory computer-readable storage medium storing an application program, the application program causing a computer of an information processing apparatus to support software capable of generating print data printable by printing apparatuses of a plurality of manufacturers, and causing the information processing apparatus to transmit the print data to the printing apparatuses of the plurality of manufacturers, and cause the printing apparatus to execute an image data generating processing that generates image data of a copy-forgery-inhibited pattern image that comes up when a piece of printed matter is copied, the image data being assigned to the piece of printed matter printed based on print data generated by the software.

### BACKGROUND OF THE INVENTION

### Field of the Invention

The present invention relates to a storage medium storing a program, a control method, and an information processing apparatus.

### Description of the Related Art

A host computer (an information processing apparatus) capable of processing information to and from a printing apparatus is communicably connected to the printing apparatus that performs printing. As control software for controlling the printing apparatus, for example, a printer driver installed from the printing apparatus into the host computer is used. This printer driver allows the host computer to issue a printing instruction to the printing apparatus. An operating system (hereinafter, referred to as “an OS”), which is basic software, has been installed in advance into the host computer. The printer driver is configured in accordance with the specifications defined by the OS, and is able to operate by being called out from the OS. In addition, such printer drivers differ depending on vendors that supply printing apparatuses, that is, they are model-specific printer drivers suitable for each printing apparatus.

In recent years, Windows (registered trademark) provides a standard class driver (hereinafter, sometimes referred to as “a standard driver”) that can be used in common even for printing apparatuses supplied by a plurality of different vendors. Such a standard driver has been built into the OS in advance. Furthermore, it is possible to use the standard driver by connecting any printing apparatus to the host computer having the OS, into which the standard driver has been built. As a result, it is possible to omit installing the model-specific printer driver. In addition, the standard driver is able to be used in designating a print function on the printing apparatus according to print device capabilities (hereinafter, referred to as “PDC”) generated based on information obtained from the printing apparatus. As a result, it is possible to designate the print function for each printing apparatus by using one standard driver. A function extension application (hereinafter, sometimes referred to as “an extended application”) that extends functions is able to be associated with the standard driver. The extended application is provided by each vendor.

Japanese Laid-Open Patent Publication (kokai) No. 2020-166433 discloses a support program that extends the print function of a printer communicably connected to an information processing apparatus. In the case that a printing instruction has been issued with respect to a general purpose printing program that has been built into the operating system of the information processing apparatus in advance, this support program is able to be extended to be capable of executing a compositing processing that composites a specific object onto an image to be printed. This compositing processing is a function that is not included in the general purpose printing program, but is able to be executed by the support program. In addition, in the case that the printed matter (the printouts) outputted from the printer is, for example, an important document, it is possible to composite and print a mark such as a watermark, which indicates that it is an important document, onto the printed matter by the compositing processing.

However, even in the case that the watermark has been printed on the printed matter, it is not possible to restrict copying (reproducing) the printed matter.

### SUMMARY OF THE INVENTION

Accordingly, the present invention provides a non-transitory computer-readable storage medium storing an application program, the application program causing a computer of an information processing apparatus to support software capable of generating print data printable by printing apparatuses of a plurality of manufacturers, and causing the information processing apparatus to transmit the print data to the printing apparatuses of the plurality of manufacturers, and cause the printing apparatus to execute an image data generating processing that generates image data of a copy-forgery-inhibited pattern image that comes up when a piece of printed matter is copied, the image data being assigned to the piece of printed matter printed based on print data generated by the software.

Accordingly, the present invention provides a non-transitory computer-readable storage medium storing an application program, the application program causing a computer of an information processing apparatus to support software capable of generating print data printable by printing apparatuses of a plurality of manufacturers, and causing the information processing apparatus to transmit the print data to the printing apparatuses of the plurality of manufacturers, and execute an image data generating processing that generates image data of a copy-forgery-inhibited pattern image that comes up when a piece of printed matter is copied, the image data being assigned to the piece of printed matter printed based on print data generated by the software.

Further features of the present invention will become apparent from the following description of exemplary embodiments with reference to the attached drawings.

### BRIEF DESCRIPTION OF THE DRAWINGS

FIG. 1 is a block diagram that shows a hardware configuration of a printing system according to a first embodiment.

FIG. 2A and FIG. 2B are block diagrams that show software configurations of the printing system.

FIGS. 3A, 3B, 3C, 3D, 3E, and 3F are diagrams that show examples of screens displayed on a display unit of the printing system by a print setting screen extending unit.

FIG. 4 is a flowchart that shows a processing in which a print function extending unit edits print function information.

FIG. 5 is a diagram that shows an example of a list (a table) of capability information of a printing apparatus.

FIG. 6 is a diagram that shows an example of a list of print functions supported by an extended application.

FIG. 7 is a diagram that shows an example of a list (a table) of capability information of general purpose printing software.

FIG. 8 is a sequence diagram that shows processes executed between a rendering application, the general purpose printing software, the extended application, and the printing apparatus after the rendering application accepts a print setting.

FIG. 9 is a diagram that shows an example of a copy-forgery-inhibited pattern image.

FIG. 10 is a flowchart that shows an image data generating processing that generates image data of the copy-forgery-inhibited pattern image.

FIGS. 11A, 11B, 11C, 11D, 11E, 11F, and 11G are conceptual diagrams that show an example of a latent image part and a background part.

FIGS. 12A, 12B, 12C, and 12D are conceptual diagrams that show an example of a sample relating to a copy-forgery-inhibited pattern.

FIG. 13 is a flowchart that shows a calibration processing of the copy-forgery-inhibited pattern.

FIG. 14 is a block diagram that shows a software configuration of a printing system according to a second embodiment.

FIG. 15 is a flowchart that shows a processing in which a print function extending unit edits print function information.

FIG. 16 is a diagram that shows an example of a list (a table) of capability information of a printing apparatus.

FIG. 17A and FIG. 17B are diagrams showing a sequence diagram that shows processes executed between the rendering application, the general purpose printing software, an extended application, and the printing apparatus after the rendering application accepts a print setting.

### DESCRIPTION OF THE EMBODIMENTS

The present invention will now be described in detail below with reference to the accompanying drawings showing embodiments thereof.

Hereinafter, each embodiment of the present invention will be described in detail with reference to the drawings. However, the configuration described in each embodiment below is merely an example, and the scope of the present invention is not limited by the configuration described in each embodiment. For example, each unit (each component) constituting the present invention can be replaced with a unit (a component) with any configuration that can perform the same function. In addition, any components may be added. Furthermore, any two or more configurations (features) of each embodiment can be combined.

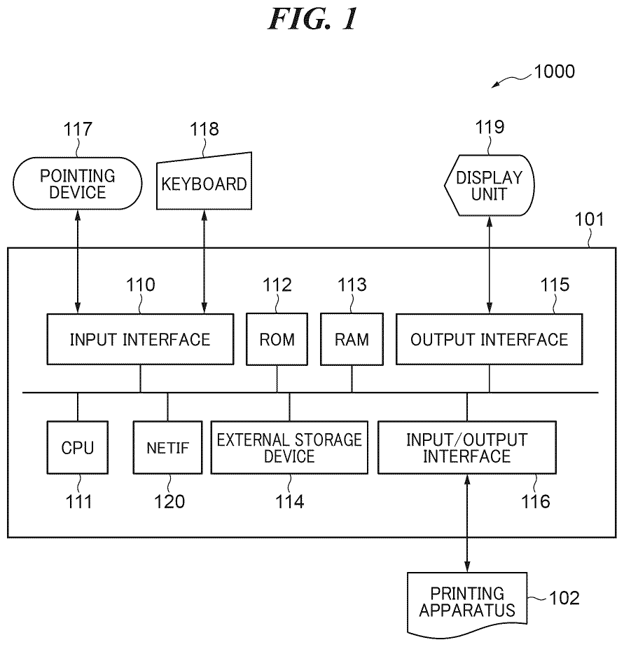

A first embodiment of the present invention will be described below with reference to FIGS. 1 to 13.

### <Hardware Configuration of Printing System>

FIG. 1 is a block diagram that shows a hardware configuration of a printing system according to the first embodiment. As shown in FIG. 1, a printing system 1000 includes a host computer 101, a printing apparatus 102, a pointing device 117, a keyboard 118, and a display unit 119, and the host computer 101, the printing apparatus 102, the pointing device 117, the keyboard 118, and the display unit 119 are communicably connected to each other.

The host computer 101 is an information processing apparatus, and includes an input interface 110, a central processing unit (a CPU) 111, a read only memory (a ROM) 112, a random access memory (a RAM) 113, an external storage device (a recording medium) 114, an output interface 115, an input/output interface 116, and a NETIF 120. It should be noted that the host computer 101 may be, for example, a desktop type personal computer, but is not limited to this, and for example, may be a notebook type personal computer, a tablet terminal, a smartphone, or the like.

The CPU 111 executes programs and the like that have been stored in the ROM 112 and the external storage device 114. The ROM 112 stores an initialization program. The external storage device 114 stores an application program group (a group of application programs), an operating system (an OS), print data generation software, and other various kinds of data. It should be noted that in the present embodiment, Windows (registered trademark) 11 by Microsoft (registered trademark) has been installed into the host computer 101 as the OS. The RAM 113 is used as a working memory or the like when executing various kinds of programs stored in the external storage device 114, and the various kinds of programs are able to run within the host computer 101. The pointing device 117 and the keyboard 118, which are input devices, are connected to the input interface 110. The display unit 119, which is a display device, is connected to the output interface 115. The display unit 119 displays, for example, a print setting screen and a detailed setting screen, which will be described below. The NETIF 120 is a network interface, and performs control for performing data transfer with an external device (not shown) via a network (not shown). The printing device 102 is connected to the input/output interface 116. As a result, the host computer 101 becomes capable of communicating with printing apparatuses 102 from a plurality of manufacturers, regardless of the manufacturer of the printing apparatus 102, that is, becomes capable of processing information to and from the printing apparatuses 102 from the plurality of manufacturers.

The printing apparatus 102 may be, for example, a multi-function peripheral (an MFP) having a plurality of functions such as copying, printing, and faxing, but is not limited to this. In addition, in the present embodiment, the printing performed by the printing apparatus 102 is electrophotographic printing, but is not limited to this and can also be, for example, inkjet printing or the like. In addition, in the present embodiment, the host computer 101 and the printing apparatus 102 are configured as separate apparatuses, but the present invention is not limited to this. For example, the host computer 101 and the printing apparatus 102 may be configured as an integrated apparatus.

### <Configuration of Printing System Centered on Software>

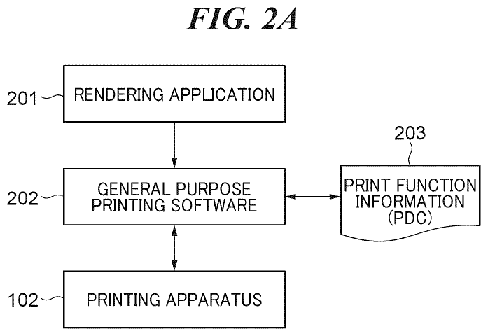

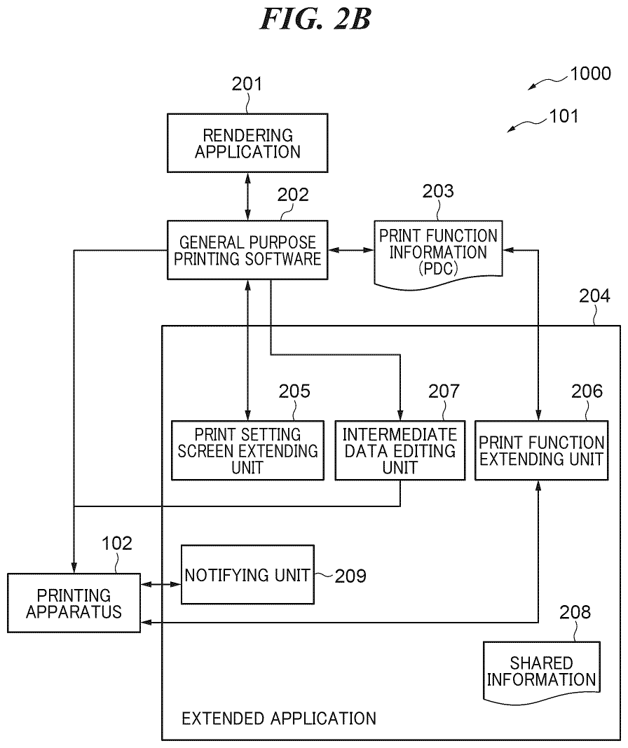

FIG. 2A and FIG. 2B are block diagrams that show software configurations of the printing system. FIG. 2A is a diagram that shows a general configuration in the case that an extended application (a program) 204 has not been associated with general purpose printing software (a general purpose program) 202 and the printing apparatus 102. Furthermore, FIG. 2B is a diagram that shows a configuration in the case that the extended application 204 has been associated with the general purpose printing software 202 and the printing apparatus 102. The general purpose printing software 202 is a program that can be used when printing in common with respect to the printing apparatuses 102 from the plurality of manufacturers, and has been installed into the OS in advance. As the general purpose printing software 202, a program that runs based on the internet printing protocol (the IPP) is used. The extended application 204 is an extended program (a program that executes a control method) that is capable of extending the functions of the general purpose printing software 202, and is sometimes referred to as “printing software”. The extended application 204 has been stored in the external storage device 114 together with, for example, the OS (the general purpose printing software 202). As a result, it becomes possible for the host computer 101 to include the general purpose printing software 202 and the extended application 204.

<Case where No Extended Application has been Associated>

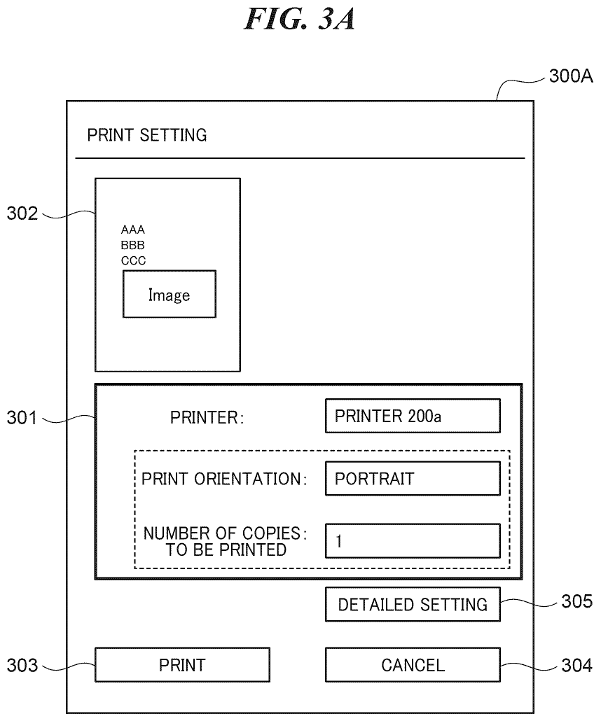

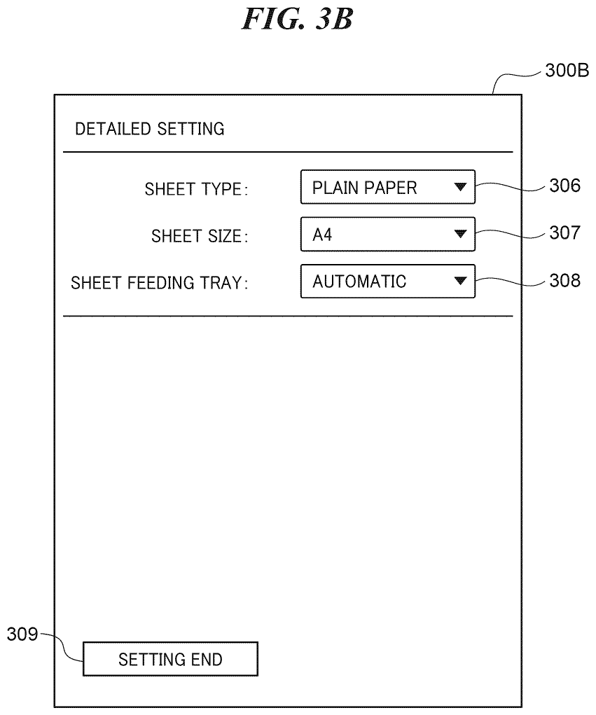

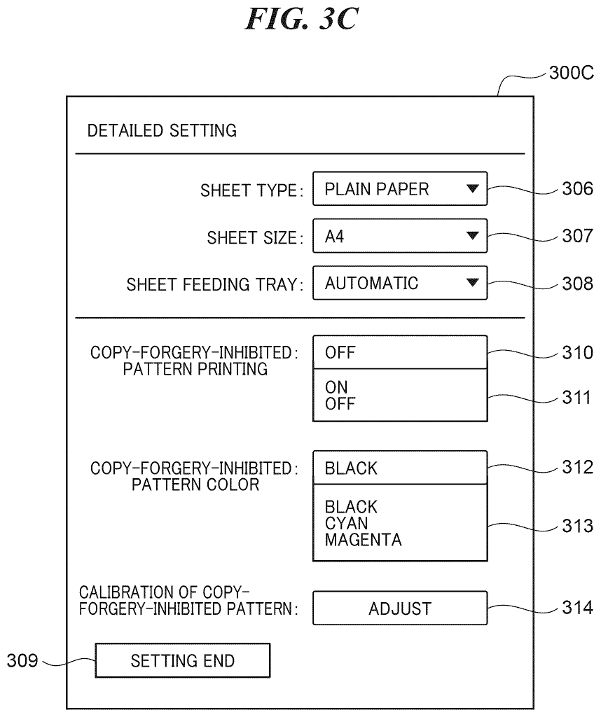

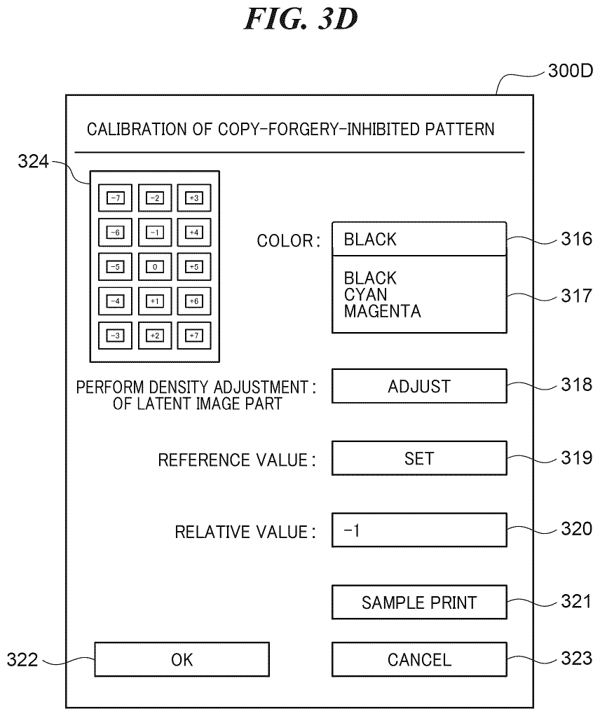

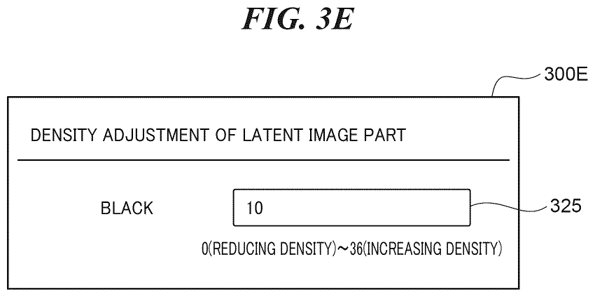

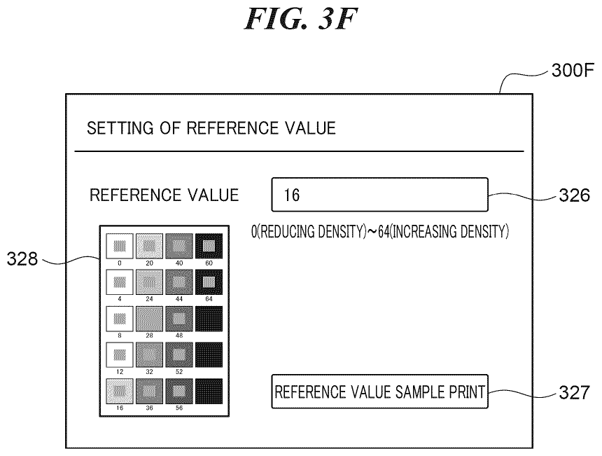

The case that the extended application 204 has not been associated with the general purpose printing software 202 and the printing apparatus 102 will be described with reference to FIG. 2A. A rendering application 201 is software that creates contents (print data) to be printed by the printing apparatus 102. The rendering application 201 is not particularly limited, and examples of the rendering application 201 include, for example, a document creation application, a spreadsheet application, etc. The rendering application 201 issues a printing instruction to the OS by receiving a printing request from a user, for example, via the keyboard 118. The printing instruction includes print setting information for instructing the operations of the general purpose printing software 202 and the printing apparatus 102. The print setting information is also referred to as “a print ticket (a PT)”. In addition, in order to output the print setting information, the rendering application 201 is able to cause the display unit 119 to display a print setting screen 300A (see FIG. 3A) provided by any one of the general purpose printing software 202, the OS, and the rendering application 201. In addition, when a control 305 within the print setting screen 300A is operated (pressed), the general purpose printing software 202 is able to cause the display unit 119 to display a detailed setting screen 300B (see FIG. 3B) or a detailed setting screen 300C (see FIG. 3C). The print setting screen 300A, the detailed setting screen 300B, and the detailed setting screen 300C will be described below. The print setting screen 300A includes setting items indicating print functions that can be set and control items indicating their setting values, according to capability information obtained from the general purpose printing software 202, that is, information that can be set as a print setting. The capability information is information about the capabilities of the printing apparatus 102 to perform printing, and is also referred to as “print capabilities” (hereinafter, sometimes referred to as “PC”). In addition, it is also possible to determine, based on this capability information, whether or not the printing apparatus 102 is capable of executing a copy-forgery-inhibited pattern image data generating processing (a determining step). “The copy-forgery-inhibited pattern image data generating processing” refers to a processing that generates image data of a copy-forgery-inhibited pattern image that comes up (appears) when copied.

The general purpose printing software 202 determines the PC based on print function information 203. The print function information 203 is data indicating print functions in which all settable print functions, their setting values, exclusive relationships between the setting values, and the like have been described. The print function information 203 is also referred to as “print device capabilities (PDC)”. The print function information 203 is included in the configuration file of the general purpose printing software 202 and is placed in the external storage device 114 as an unchangeable file. Alternatively, the print function information 203 is dynamically generated by the general purpose printing software 202. Specifically, the general purpose printing software 202 obtains attribute data of the printing apparatus 102 from the printing apparatus 102. The general purpose printing software 202 generates the print function information 203 according to attribute information within this attribute data. It should be noted that in the case that the print function information 203 is dynamically generated in this way, editing of the print function information 203 is possible. In addition, the attribute data of the printing apparatus 102 is a response obtained by issuing an IPP “Get-Printer-Attributes” operation to the printing apparatus 102. The response includes attribute information indicating functions that can be designated in the printing apparatus 102, that is, the capabilities of the printing apparatus 102, and setting values related to the attribute information. In addition, the response is stored in the RAM 113.

With such a configuration, the general purpose printing software 202 allows the user to designate print functions that can be used in the printing apparatus 102, depending on the printing apparatus 102 connected to the general purpose printing software 202. As a result, regardless of the printing apparatus 102 connected to the general purpose printing software 202, that is, even in the case that a printing apparatus with different functions or a printing apparatus developed by a different printer manufacturer is connected, it becomes possible to designate print functions that can be used in the printing apparatus with different functions or the printing apparatus developed by the different printer manufacturer. It should be noted that in the present embodiment, it is assumed that the general purpose printing software 202 is configured to use “IPP Class Driver” installed in Windows (registered trademark) 11. “IPP Class Driver” is a printer driver that executes a print processing according to the specifications of a standard printing protocol called the IPP, and is bundled with the package of the OS. “IPP Class Driver” is not a unique printer driver depending on the model of the printing apparatus 102, but a standard class driver that can be used in common by the printing apparatuses 102 of various printer manufacturers regardless of the printer manufacturer. In addition, “IPP Class Driver” obtains capability information of the printing apparatus 102, and generates the print function information 203 based on the capability information of the printing apparatus 102. In addition, it is possible to associate the general purpose printing software 202 with the extended application 204. As a result, it is possible to execute functions not included in the general purpose printing software 202 by the general purpose printing software 202. The IPP Class Driver (the general purpose printing software 202) is not capable of executing the copy-forgery-inhibited pattern image data generating processing (an image data generating processing) that generates the image data of the copy-forgery-inhibited pattern image, that is, it does not support the execution of the copy-forgery-inhibited pattern image data generating processing. This is because the copy-forgery-inhibited pattern image data generating processing is a function that is executed independently by the printing apparatus 102 manufactured by the printer manufacturer. The extended application 204 is able to be extended to be capable of executing the copy-forgery-inhibited pattern image data generating processing that the IPP Class Driver is not able to execute. In the present embodiment, the IPP Class Driver is not able to execute the copy-forgery-inhibited pattern image data generating processing, and the extended application 204 is able to be extended to be capable of executing the copy-forgery-inhibited pattern image data generating processing, but the present invention is not limited to this. For example, the IPP Class Driver is able to execute a part of the copy-forgery-inhibited pattern image data generating processing, and the extended application 204 may supplement the shortage of the copy-forgery-inhibited pattern image data generating processing to further extend the scope of the execution.

### <Copy-Forgery-Inhibited Pattern Function>

Here, a copy-forgery-inhibited pattern function will be described. “A copy-forgery-inhibited pattern image (sometimes simply referred to as “a copy-forgery-inhibited pattern”)” refers to an image that comes up when copied, that is, an image in which something hidden becomes to appear on the surface and become visible, and in the present embodiment, the copy-forgery-inhibited pattern image has a background part that disappears after copying and a latent image part that remains after copying. The latent image part is made up of dots that are relatively large in size, and the background part is made up of dots that are smaller than the dots in the latent image part. In addition, the latent image part and the background part are able to be added to the document so that each area has the same density. Even in the case that a word “no copying” has been rendered with the large dots in the latent image part, a printout that has been printed out by the printing apparatus 102 will have the same density as the small dots in the background part, and the word “no copying” will not be read. Furthermore, when this printout is copied (duplicated), due to the influences of the dot reproduction limits of a copying machine, a background color removal processing, etc., on the copy of the printout, the background part made up of the small dots disappears, leaving only the latent image part made up of the large dots. As a result, only the word “no copying” comes up (appears) on the copy of the printout. “The copy-forgery-inhibited pattern function” is a function that prevents unauthorized copying (unauthorized duplicating).

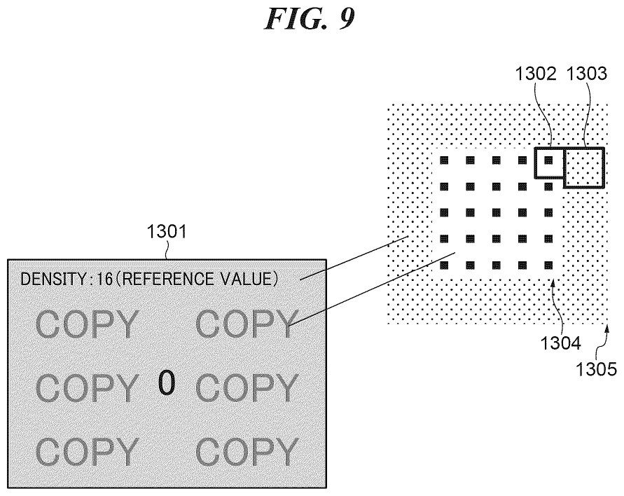

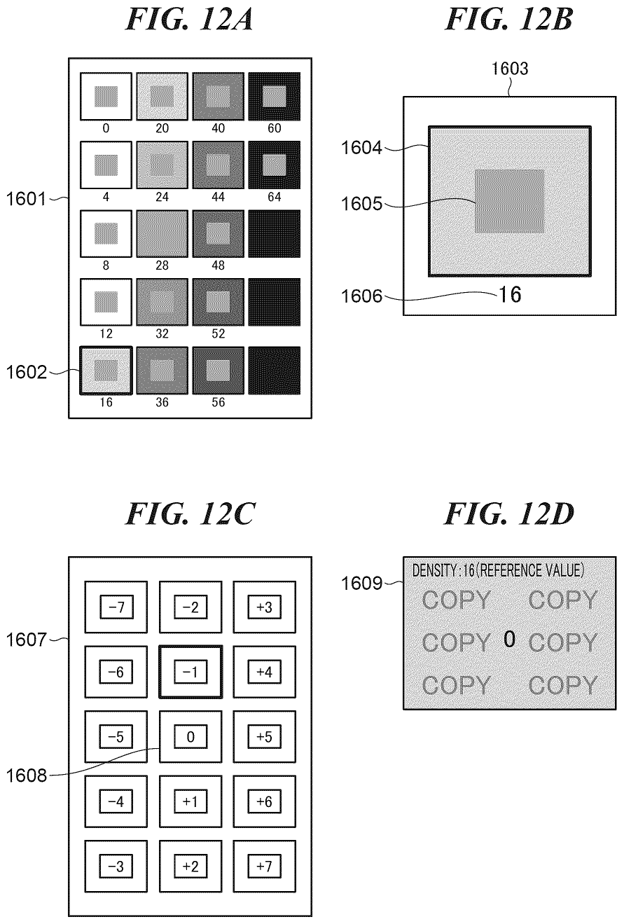

FIG. 9 is a diagram that shows an example of the copy-forgery-inhibited pattern image. The left side of FIG. 9 shows a sample image 1301 of the copy-forgery-inhibited pattern image, and the right side of FIG. 9 is an enlarged view of a part of the sample image 1301. As shown in the right side of FIG. 9, the sample image 1301 has a latent image part 1304 that constitutes characters “COPY” and a background part 1305 that becomes the background of the characters “COPY”. The latent image part 1304 is made up of a plurality of large dots 1302 that are relatively large in size. The background part 1305 is made up of a plurality of small dots 1303 that are smaller than the large dots 1302. Both the large dots 1302 and the small dots 1303 are applied as isolated full dots (eight bits of data out of eight bits). In the case of adjusting the density of the latent image part 1304, the size of the large dot 1302 is changed. For example, in the case of adjusting the density of the latent image part 1304 to be higher, the size of the large dot 1302 is enlarged, that is, the size of the large dot 1302 is made larger. On the other hand, in the case of adjusting the density of the latent image part 1304 to be lower, the size of the large dot 1302 is reduced, that is, the size of the large dot 1302 is made smaller. In the present embodiment, in the case of adjusting the density of the latent image part 1304, for example, in a unit of 10×10 pixels, it is possible to change one large dot 1302 in size from 0 to 36 (a square of 6 pixels×6 pixels). In the case of adjusting the density of the background part 1305, the number of the small dots 1303 is changed. For example, in the case of adjusting the density of the small dots 1303 to be higher, the number of the small dots 1303 per unit area is increased, that is, the number of the small dots 1303 per unit area is made to increase. On the other hand, in the case of adjusting the density of the small dots 1303 to be lower, the number of the small dots 1303 per unit area is decreased, that is, the number of the small dots 1303 per unit area is made to decrease. It should be noted that in the density adjustment of the background part 1305, for example, in a unit of 16×16 pixels, it is preferable to arrange 0 to 64 small dots 1303 of 1 pixel×2 pixels so as to prevent them from contacting each other. In addition, “0” in the sample image 1301 is a fine adjustment value for the density of the background part (see FIG. 12C and FIG. 12D).

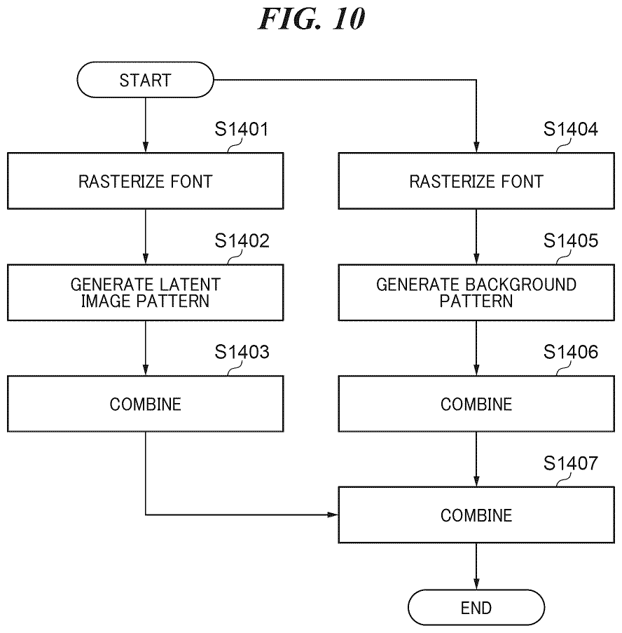

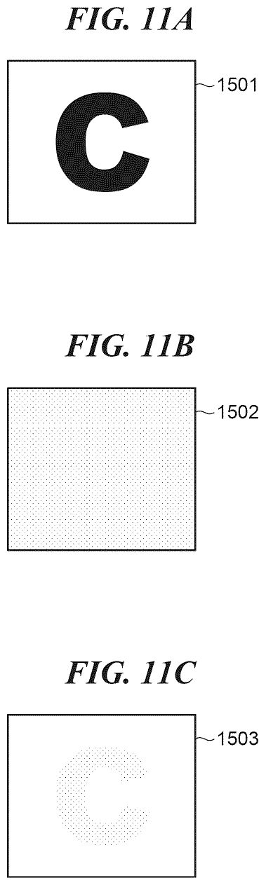

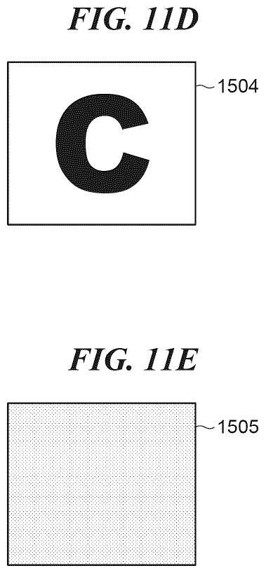

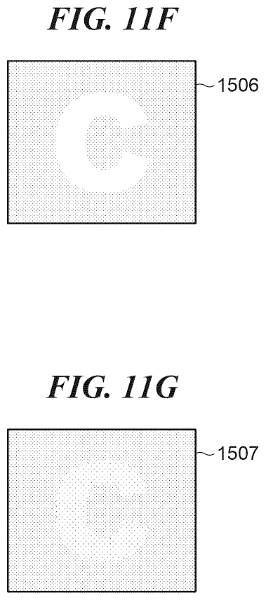

FIG. 10 is a flowchart that shows the image data generating processing that generates the image data of the copy-forgery-inhibited pattern image. A program based on the flowchart shown in FIG. 10 is executed by, for example, the CPU 111 of the host computer 101 or a CPU (not shown) of the printing apparatus 102. Here, the CPU 111 of the host computer 101 or the CPU of the printing apparatus 102 is simply referred to as “the CPU”. FIGS. 11A, 11B, 11C, 11D, 11E, 11F, and 11G are conceptual diagrams that show an example of the latent image part and the background part. As shown in FIG. 10, in a step S1401, the CPU rasterizes the font of a character string included in the copy-forgery-inhibited pattern image. For example, “C” in “COPY” is generated as an illustrative image 1501 shown in FIG. 11A.

In a step S1402, the CPU generates a pattern of the latent image part. In generating the pattern of the latent image part, for example, data, in which full dots of 3×3=9 pixels are added to a white background of a unit of 10×10, is generated. Then, by repeatedly arranging this pattern, a pattern of an illustrative image 1502 shown in FIG. 11B is generated.

In a step S1403, the CPU combines the illustrative image 1501 generated in the step S1401 and the illustrative image 1502 generated in the step S1402. By combining the illustrative image 1501 and the illustrative image 1502, an illustrative image 1503 shown in FIG. 11C is generated. In the illustrative image 1503, for example, “C” is generated by using the large dots.

In a step S1404, the CPU rasterizes the font of the character string included in the copy-forgery-inhibited pattern image. For example, “C” in “COPY” is generated as an illustrative image 1504 shown in FIG. 11D. It should be noted that in the step S1404, “C” may be made bolder. As a result, a space is formed between the latent image part and the background part.

In a step S1405, the CPU generates a pattern of the background part. In generating the pattern of the background part, for example, data, in which ten groups of 1 pixel×2 pixels full dots are distributed and arranged on a white background of a unit of 16×16, is generated. Then, by repeatedly arranging this pattern, a pattern of an illustrative image 1505 shown in FIG. 11E is generated.

In a step S1406, the CPU combines the illustrative image 1504 generated in the step S1404 and the illustrative image 1505 generated in the step S1405. By combining the illustrative image 1504 and the illustrative image 1505, an illustrative image 1506 shown in FIG. 11F is generated. In the illustrative image 1506, for example, only “C” becomes a white background, and the rest is generated as the background part by using the small dots.

In a step S1407, the CPU combines the illustrative image 1503 generated in the step S1403 and the illustrative image 1506 generated in the step S1406. By combining the illustrative image 1503 and the illustrative image 1506, an illustrative image 1507 shown in FIG. 11G is generated as the image data of the copy-forgery-inhibited pattern image.

### <Density Adjustment to Achieve the Effect of Copy-Forgery-Inhibited Pattern Image>

A calibration function of the copy-forgery-inhibited pattern image will be described. By executing the calibration function, the effect of the copy-forgery-inhibited pattern image is enhanced. As described above, the effect of the copy-forgery-inhibited pattern image is achieved by outputting the large dots and the small dots with a fixed density, respectively. However, the small dots may not be outputted with the fixed density due to factors such as the printing performance of the copying machine (the printer or the printing apparatus) and the quality of a paper medium on which the copy-forgery-inhibited pattern image is printed. In addition, when outputting the copy-forgery-inhibited pattern image, it is necessary to perform the density adjustment so that the latent image part and the background part are outputted with the same density. Therefore, in the calibration function of the copy-forgery-inhibited pattern image, a sample for the density adjustment is printed, and it is possible to reset the density of the latent image part and the background part that is considered to be optimal based on the outputted printout. The details of the calibration function of the copy-forgery-inhibited pattern will be described below.

Here, returning to the description with reference to FIG. 2A. The OS generates intermediate data (sometimes referred to as “input data”) based on the printing instruction outputted from the rendering application 201 and transmits it to the general purpose printing software 202. The data that the rendering application 201 outputs for printing is not particularly limited, and for example, is preferably data in an XML Paper Specification format (an XPS format). In addition, the data that the rendering application 201 outputs for printing may be data in a Graphic Device Interface format (a GDI format). In the case that the general purpose printing software 202 uses “IPP Class Driver”, if the data that the rendering application 201 outputs is data in the GDI format, the OS converts the data in the GDI format into data in the XPS format. Then, the OS transmits the converted data in the XPS format to the general purpose printing software 202 as the intermediate data. In addition, if the data that the rendering application 201 outputs is data in the XPS format, the OS transmits the data in the XPS format to the general purpose printing software 202 as the intermediate data. It should be noted that the intermediate data includes rendering data, which is information such as characters and figures that are formed on a print medium, and the print setting information set by the user.

The general purpose printing software 202 converts the intermediate data into the print data (the image data) that can be processed, that is, that can be printed by the printing apparatus 102 (a converting step), and transmits it to the printing apparatus 102. Here, “the print data” in the present embodiment refers to page description language data (PDL data) conforming to the IPP. The PDL data is, for example, data in portable document format (PDF data) or data in PWG-Raster format. It should be noted that the print data includes the rendering data, which is the information such as characters and figures that are formed on the print medium, and print setting attribute information, which is generated based on the print setting information set by the user and designates the print setting. The print setting attribute information includes the attribute information indicating the functions that can be designated in the printing apparatus 102, that is, the capabilities of the printing apparatus 102, and the setting values related to the attribute information.

The printing apparatus 102 performs printing on the print medium based on the print data transmitted from the general purpose printing software 202. At this time, the printing apparatus 102 is able to form the rendering data included in the print data on the print medium by performing an operation according to the print setting attribute information included in the print data. It should be noted that the print setting attribute information includes, for example, attribute information for designating print quality such as image quality priority or speed priority, double-sided printing or single-sided printing, etc., and setting values of the attribute information. For example, in the case that the print setting attribute information includes attribute information designating double-sided printing, the printing apparatus 102 is able to execute double-sided printing.

<Case where Extended Application has been Associated>

The case that the extended application 204 has been associated with the general purpose printing software 202 and the printing apparatus 102 will be described with reference to FIG. 2B. As shown in FIG. 2B, unlike FIG. 2A, the extended application 204 has been added. That is, the host computer 101 includes the rendering application 201, the general purpose printing software 202, and the print function information 203, and further includes the extended application 204. The extended application 204 is software for extending the functions of the general purpose printing software 202. It should be noted that the extended application 204 is software that is not included in the OS in advance (is not bundled with the OS). Therefore, the extended application 204 is downloaded from a server (not shown) via the Internet by the user operating the host computer 101, and is installed into the host computer 101. Alternatively, when the printing apparatus 102 is connected to the host computer 101, the extended application 204 may be automatically installed into the host computer 101 based on this connection. Specifically, in the case that the printing apparatus 102 is connected to the host computer 101, the OS obtains device identification information from the printing apparatus 102. The OS may download the extended application 204 corresponding to this device identification information from the server via the Internet and then install it. As a result, the general purpose printing software 202 and the extended application 204 are held in the host computer 101 as separate control programs. It should be noted that the general purpose printing software 202 and the extended application 204 may be updated and upgraded, respectively. In this case, an update processing of the general purpose printing software 202 and an update processing of the extended application 204 may be performed at the same timing or at different timings. In addition, a trigger for the host computer 101 to obtain the general purpose printing software 202 and a trigger for the host computer 101 to obtain the extended application 204 may be the same trigger or may be different triggers. In addition, in the case that the extended application 204 has been installed, the OS associates the extended application 204 with the general purpose printing software 202 and the printing apparatus 102.

As shown in FIG. 2B, the extended application 204 is capable of exchanging information with the general purpose printing software 202 and the printing apparatus 102, respectively, that is, the extended application 204 is capable of transmitting and receiving information to and from the general purpose printing software 202 and the printing apparatus 102, respectively. In other words, the extended application 204 has been associated with the general purpose printing software 202 and the printing apparatus 102. In the present embodiment, the extended application 204 includes a print setting screen extending unit 205, a print function extending unit 206, an intermediate data editing unit 207, and a notifying unit 209. In addition, the extended application 204 includes shared information 208 that can be accessed from each unit of the print setting screen extending unit 205, the print function extending unit 206, the intermediate data editing unit 207, and the notifying unit 209. The shared information 208 is a file stored in the external storage device 114 or information stored in the RAM 113. The extended application 204 is able to perform writing and reading of the shared information 208 by using an application program interface (an API) provided by the OS.

It should be noted that the extended application 204 may end the operation of the extended application 204 as a whole when the processing of each unit of the print setting screen extending unit 205, the print function extending unit 206, the intermediate data editing unit 207, and the notifying unit 209 ends. In this case, the OS activates the extended application 204 every time it receives a processing execution request from each unit of the print setting screen extending unit 205, the print function extending unit 206, the intermediate data editing unit 207, and the notifying unit 209. Furthermore, the OS causes to end the operation of the extended application 204 as a whole for example, in the case that the processing of the print setting screen extending unit 205 ends. Furthermore, the extended application 204 may cancel the processing of each unit of the print setting screen extending unit 205, the print function extending unit 206, the intermediate data editing unit 207, and the notifying unit 209 during the processing of each unit of the print setting screen extending unit 205, the print function extending unit 206, the intermediate data editing unit 207, and the notifying unit 209. In this case, a job being processed on a print queue is deleted by the OS. As described above, the rendering application 201 issues a printing instruction to the OS upon receiving a printing request from the user. In addition, the rendering application 201 is able to cause to display a print setting screen. In the configuration shown in FIG. 2B, the rendering application 201 is able to cause to display the print setting screen 300A (the detailed setting screen 300C) provided by the print setting screen extending unit 205 (the extended application 204). In addition, the print setting screen extending unit 205 is able to store a detailed setting set by the user in the shared information 208. The details of the print setting screen extending unit 205 will be described below.

The intermediate data editing unit 207 obtains the intermediate data from the general purpose printing software 202. Then, the intermediate data editing unit 207 converts the intermediate data into print data, and then transmits the print data to the printing apparatus 102. In addition, the intermediate data editing unit 207 obtains detailed setting information from the shared information 208 and adds the detailed setting to the print data. The printing apparatus 102 performs printing on the print medium based on the print data from the intermediate data editing unit 207. It should be noted that the extended application 204 may be configured to obtain the print data generated by the general purpose printing software 202 and add the detailed setting to the print data. In addition, even in the case of the configuration of FIG. 2B, there is a case where the copy-forgery-inhibited pattern and the calibration of the copy-forgery-inhibited pattern are not performed. In this case, the general purpose printing software 202 may transmit the print data to the printing apparatus 102 without going through the extended application 204.

The print function extending unit 206 is able to edit the print function information 203 (the PDC) generated by the general purpose printing software 202 or the OS. As a result, it is possible to perform the addition of functions provided by the extended application 204. Furthermore, it is also possible to perform the addition of the copy-forgery-inhibited pattern function and the calibration function of the copy-forgery-inhibited pattern that can be executed by the printing apparatus 102, but cannot be executed by the general purpose printing software 202, the addition of the exclusive relationships between the setting values of the print functions, and the like. The OS activates the print function extending unit 206 when the extended application 204 has been first associated with the printing apparatus 102 and the general purpose printing software 202.

Furthermore, the OS may activate the print function extending unit 206 at other timings (for example, when the OS is activated). With such activation, even in the case that a printing-related function is extended later, the print function extending unit 206 is able to detect the extended printing-related function and add it to the print function information 203. An example of the case that the printing-related function is extended later is a case of adding an optional device (for example, a finisher or the like) to the printing apparatus 102 later.

The notifying unit 209 is able to, when an error occurs in the printing apparatus 102, notify that the error occurs in the printing apparatus 102. For example, in the case that a sheet out error occurs in the printing apparatus 102, the general purpose printing software 202 detects the occurrence of this sheet out error. By using a notifying function called a toast notification, which is one of the functions of the OS, the OS causes the display unit 119 to display the occurrence of the sheet out error, which is a detection result obtained by the general purpose printing software 202, as a message. It should be noted that when the user operates the toast notification, the notifying unit 209 is called out by the OS, and a user interface screen of the notifying unit 209 is displayed. On the user interface screen (a UI screen), for example, a detailed message regarding the sheet out error, a sheet filling method, etc. can be displayed.

As described above, in the present embodiment, it can be said that the extended application 204 includes the following four functions. The first function is a function to display a setting screen. The first function is executed by the print setting screen extending unit 205. The second function is a function to edit the intermediate data, convert it into the print data, and add the detailed setting to the print data. The second function is executed by the intermediate data editing unit 207. The third function is a function to extend the functions that can be designated by the general purpose printing software 202 (the print data generation software). The third function is executed by the print function extending unit 206. The fourth function is a function to display a screen in response to the occurrence of an error in the printing apparatus 102. The fourth function is executed by the notifying unit 209. It should be noted that the configuration of the extended application 204 is not limited to the configuration having these four functions, and it is preferable that the configuration of the extended application 204 is a configuration having at least one function of these functions, and may also have other functions. Furthermore, once the extended application 204 has transmitted the print data to the printing apparatus 102, it is not possible to display on a screen, such as a guide linked to the print data, during the processing of each unit.

### <Example of Print Setting Screen/Detailed Setting Screen>

FIGS. 3A, 3B, 3C, 3D, 3E, and 3F are diagrams that show examples of screens displayed on the display unit of the printing system. FIG. 3A shows a print setting screen displayed by the rendering application 201. FIG. 3B shows a detailed setting screen that is displayed in the case of the configuration in which the extended application 204 has not been associated. FIG. 3C shows a detailed setting screen that is displayed in the case of the configuration in which the extended application 204 has been associated. FIG. 3D shows a copy-forgery-inhibited pattern calibration screen that is displayed when a control 314 on the detailed setting screen 300C shown in FIG. 3C has been operated. FIG. 3E shows a latent image part density adjustment screen that is displayed when a control 318 on the detailed setting screen 300C shown in FIG. 3C has been operated. FIG. 3F shows a reference value setting screen that is displayed when a control 319 on a copy-forgery-inhibited pattern calibration screen 300D shown in FIG. 3D has been operated. It should be noted that the unit or the module that displays each screen is not particularly limited. For example, the print setting screen extending unit 205 may be configured to only generate a display screen. In this case, the print setting screen extending unit 205 transmits the generated display screen to the rendering application 201 via the general purpose printing software 202. The rendering application 201 may be configured to display the obtained display screen.

The print setting screen 300A shown in FIG. 3A includes a control (a button) 301, a control 302, a control 303, a control 304, and the control 305. By using the control 301, it is possible to set the printing apparatus 102 to be used for printing, an orientation of printing in the printing apparatus 102, and the number of copies to be printed in the printing apparatus 102. In FIG. 3A, as an example, the printing apparatus 102 to be used for printing is set to “printer 200a”, the orientation of printing in the printing apparatus 102 is set to “portrait”, and the number of copies to be printed in the printing apparatus 102 is set to “1”. By using the control 302, a preview screen is displayed. By using the control 303, it is possible to instruct the printing apparatus 102 to begin printing. By using the control 304, it is possible to instruct the printing apparatus 102 to cancel printing. By using the control 305, it is possible to perform the detailed setting. By operating the control 305, an additional print screen is displayed by the general purpose printing software 202 or the print setting screen extending unit 205.

The detailed setting screen 300B shown in FIG. 3B includes a control 306, a control 307, a control 308, and a control 309. By using the control 306, it is possible to select and set the type of a sheet to be used in printing performed by the printing apparatus 102. In FIG. 3B, “plain paper” has been selected as an example. By using the control 307, it is possible to select and set the size of the sheet to be used in printing performed by the printing apparatus 102. In FIG. 3B, “A4” has been selected as an example. By using the control 308, it is possible to select a sheet feeding tray of the sheet to be used in printing performed by the printing apparatus 102. In FIG. 3B, “automatic” has been selected as an example. By using the control 309, it is possible to end the settings performed by the control 306, the control 307, and the control 308. In addition, by operating the control 309, returning to the print setting screen 300A shown in FIG. 3A.

Similar to the detailed setting screen 300B, the detailed setting screen (the setting screen) 300C shown in FIG. 3C includes the control 306, the control 307, the control 308, and the control 309. In addition, the detailed setting screen 300C further includes a control 310, a control 312, and the control 314. By using the control 310, it is possible to select whether or not to execute copy-forgery-inhibited pattern printing (the copy-forgery-inhibited pattern image data generating processing). By operating the control 310, a list 311 is displayed. The list 311 includes ON (executing the copy-forgery-inhibited pattern printing) and OFF (not executing the copy-forgery-inhibited pattern printing), either of which can be selected. In FIG. 3C, “OFF” has been selected as an example. In this manner, the control 310 functions as a selecting section for selecting whether or not to execute the copy-forgery-inhibited pattern printing. By using the control 312, it is possible to select a color of the copy-forgery-inhibited pattern. By operating the control 312, a list 313 is displayed. The list 313 includes black, cyan, and magenta, any one of which can be selected. In FIG. 3C, “black” has been selected as an example. In this manner, the control 312 functions as a color determining section that determines the color of the copy-forgery-inhibited pattern. By using the control 314, it is possible to execute the calibration of the copy-forgery-inhibited pattern. By operating the control 314, the copy-forgery-inhibited pattern calibration screen 300D shown in FIG. 3D is displayed.

Here, the reason why the items included in the detailed setting screen 300B shown in FIG. 3B are different from the items included in the detailed setting screen 300C shown in FIG. 3C will be described. The detailed setting screen 300B and the detailed setting screen 300C are each generated based on the print function information (the capability information). As described above, the general purpose printing software 202 does not support the copy-forgery-inhibited pattern and the calibration function of the copy-forgery-inhibited pattern. Therefore, it is not possible to add the copy-forgery-inhibited pattern and the calibration function of the copy-forgery-inhibited pattern to the print function information by using only the general purpose printing software 202. In addition, even in the case that the print function information originally includes the copy-forgery-inhibited pattern and the calibration function of the copy-forgery-inhibited pattern, the general purpose printing software 202 is not able to interpret the copy-forgery-inhibited pattern and the calibration function of the copy-forgery-inhibited pattern that are included in the print function information. Therefore, the general purpose printing software 202 alone is not able to display the copy-forgery-inhibited pattern setting and the calibration setting of the copy-forgery-inhibited pattern on the detailed setting screen 300B. Therefore, the print function extending unit 206 adds the copy-forgery-inhibited pattern and the calibration function of the copy-forgery-inhibited pattern to the print function information 203. Then, the print setting screen extending unit 205 refers to the capability information and causes to display the detailed setting screen 300C. As a result, the extended application 204 is able to cause to display the copy-forgery-inhibited pattern setting and the calibration setting of the copy-forgery-inhibited pattern on the detailed setting screen.

The copy-forgery-inhibited pattern calibration screen 300D shown in FIG. 3D includes a control 316, the control 318, the control 319, a control 320, a control 321, a control 322, a control 323, and a thumbnail 324. By using the control 316, it is possible to designate the color of the copy-forgery-inhibited pattern, which is an adjustment target. By operating the control 316, a list 317 is displayed. The list 317 includes black, cyan, and magenta, any one of which can be designated as the adjustment target. In FIG. 3D, “black” has been selected as an example.

By using the control 318, it is possible to adjust the density of the latent image part. By operating the control 318, a latent image part density adjustment screen 300E shown in FIG. 3E is displayed. The latent image part density adjustment screen 300E includes a control 325. By operating the control 325, it is possible to designate the density value of the latent image part from 0 to 36 in increments of 1. In this way, the control 318 and the latent image part density adjustment screen 300E function as a density adjusting section that adjusts the density of the latent image part. By using the control 319, it is possible to perform setting of a reference value. By operating the control 319, a reference value setting screen 300F shown in FIG. 3F is displayed. The reference value setting screen 300F includes a control 326, a control 327, and sample data 328. By using the control 326, it is possible to designate the reference value for the density of the background part from 0 to 64 in increments of 4. By using the control 327, the sample data 328 is generated and printed out based on the value obtained by the control 325 and the value obtained by the control 326. By using the control 320, it is possible to accept a value between −7 and +7 to finely adjust the density of the background part. In this way, the control 319, the control 320, and the reference value setting screen 300F function as a density adjusting section that adjusts the density of the background part.

By using the control 321, the sample data is generated based on the values set in the control 316, the control 318, the control 319, and the control 320, and is printed out. The control 321 functions as a print instructing section that instructs printing of a sample of the copy-forgery-inhibited pattern. It should be noted that as the sample data, the thumbnail (a sample image of the copy-forgery-inhibited pattern) 324 is displayed. In this manner, the copy-forgery-inhibited pattern calibration screen 300D includes, as an information screen including information related to the copy-forgery-inhibited pattern, the control 321 that functions as the print instructing section, and the thumbnail 324 as the sample image of the copy-forgery-inhibited pattern. It should be noted that the information screen preferably includes both the print instructing section and the sample image of the copy-forgery-inhibited pattern, but is not limited to this and may include at least one of them. Furthermore, by operating the control 322, the values set in the control 316, the control 318, the control 319, and the control 320 are saved (stored) and the process ends. By operating the control 323, the values set in the control 316, the control 318, the control 319, and the control 320 are cancelled and the process ends. In this manner, it is possible to set execution conditions of the copy-forgery-inhibited pattern printing on the detailed setting screen 300C (a setting step). In addition, in the present embodiment, as the execution conditions of the copy-forgery-inhibited pattern printing, the detailed setting screen 300C includes the selecting section that selects whether or not to execute the copy-forgery-inhibited pattern printing, the color determining section that determines the color of the copy-forgery-inhibited pattern, the density adjusting section that adjusts the density of the latent image part, and the density adjusting section that adjusts the density of the background part, but is not limited to include these. It is preferable that the execution conditions of the copy-forgery-inhibited pattern printing include at least one of the selecting section, the color determining section, the density adjusting section that adjusts the density of the latent image part, and the density adjusting section that adjusts the density of the background part. In addition, based on the respective execution conditions, the intermediate data generated by the general purpose printing software 202 is converted into image data that is used for printing the copy-forgery-inhibited pattern image by the printing apparatus 102.

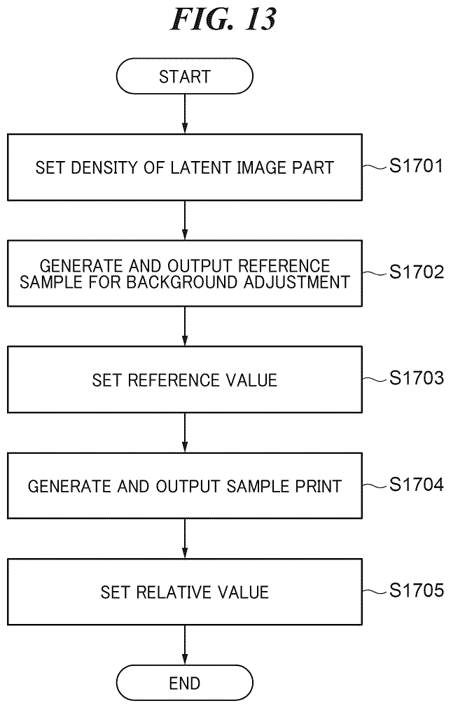

FIGS. 12A, 12B, 12C, and 12D are conceptual diagrams that show an example of a sample relating to the copy-forgery-inhibited pattern. FIG. 12A is a conceptual diagram of a reference sample. FIG. 12B is an enlarged diagram of a patch 1602 of a reference sample 1601 shown in FIG. 12A. FIG. 12C is a sample for finely adjusting the density of the background part. FIG. 12D is an enlarged diagram of a sample 1607 shown in FIG. 12C. FIG. 13 is a flowchart that shows a calibration processing of the copy-forgery-inhibited pattern. As shown in FIG. 13, in a step S1701, the extended application 204 accepts the density of the latent image part from the latent image part density adjustment screen 300E. As described above, the latent image part made up of the large dots is made up of the large dots. The large dots are more stable than the small dots with respect to the durability of the printing apparatus 102 and the type of the paper medium. However, in the case that the latent image part is faint or in the case that the latent image part is too dark compared with the small dots in the background part, as the density value of the latent image part, a value between 0 and 36 is inputted into the control 325 on the latent image part density adjustment screen 300E. As a result, the density of the latent image part is adjusted.

In a step S1702, the extended application 204 instructs the printing apparatus 102 to generate and output a reference sample for adjusting the density of the background part. For example, in the case that the density of the background part and the density of the latent image part are clearly different, the reference sample 1601 shown in FIG. 12A, in which patches of the background part are arranged with a gap between the densities, is generated and outputted. A patch 1603 shown in FIG. 12B includes a background part 1604 and a latent image part 1605. The latent image part 1605 is common to all patches within the reference sample 1601, and is outputted with the density of the latent image part set in the step S1701. The background part 1604 is formed by discretely arranging 16 background dots (see a portion indicated by a reference numeral 1606) of 1 pixel×2 pixels in a unit of 16×16 pixels so as not to be adjacent to each other, and repeating this pattern. In addition, similarly, the other patches within the reference sample 1601 also have background dots added to them, as indicated by the numbers below the patches. In this single chart, the patches are arranged in which the number of dots in the background part (the background dots) is changed every four, from 0, 4, . . . , 64. In this reference sample 1601, the density of the background part is changed over a relatively wide range, so it is considered that a patch of the background part close to the latent image part exists somewhere. Therefore, by outputting one sheet of the reference sample 1601, it is possible to understand roughly what the density of the background part should be. In addition, the reference sample 1601 is outputted by operating the control 327 on the latent image part density adjustment screen 300E.

In a step S1703, the extended application 204 accepts, as the density of the background part, the reference value from the latent image part density adjustment screen 300E. Here, the number “16 (see the portion indicated by the reference numeral 1606)”, which selects a patch whose latent image part and background part are close to each other from the printout of the reference sample 1601, is inputted into the control 326 on the latent image part density adjustment screen 300E.

In a step S1704, the extended application 204 instructs the printing apparatus 102 to generate and output a sample for finely adjusting the density of the background part. Here, as the sample for finely adjusting the density of the background part to bring the density of the background part and the density of the latent image part closer to each other, for example, the sample 1607 shown in FIG. 12C is generated and outputted. This sample 1607 is made up of 15 patches, with the density of the background part changed by 1 from −7 to +7, relative to a patch 1608 having the density of the latent image part selected in the step S1701 and the density of the background part selected in the step S1703. It should be noted that the densities of the latent image parts of all the patches on the sample 1607 are the same. Therefore, it is possible to adjust the density of the background part more finely than the above-mentioned reference value. In a patch 1609 shown in FIG. 12D, “COPY” is the latent image part, and the effect of the copy-forgery-inhibited pattern can be actually imagined. In addition, the sample 1607 is outputted by operating the control 321 on the copy-forgery-inhibited pattern calibration screen 300D.

In a step S1705, the extended application 204 accepts, as a relative value, the adjusted density of the background part (the value obtained by adjusting the density of the background part). Here, the number between −7 and +7, which is selected for a patch whose latent image part and background part are close to each other based on a printout of the sample 1607, is inputted into the control 320 on the copy-forgery-inhibited pattern calibration screen 300D. It should be noted that in the present embodiment, the reference sample 1601 and the sample 1607 are generated by the printing apparatus 102, but the present invention is not limited to this. For example, the extended application 204 may instruct the general purpose printing software 202 to create the reference sample 1601 and the sample 1607, or the extended application 204 may create the reference sample 1601 and the sample 1607.

<Flowchart of Print Function Extending Unit that Edits Print Function Information>

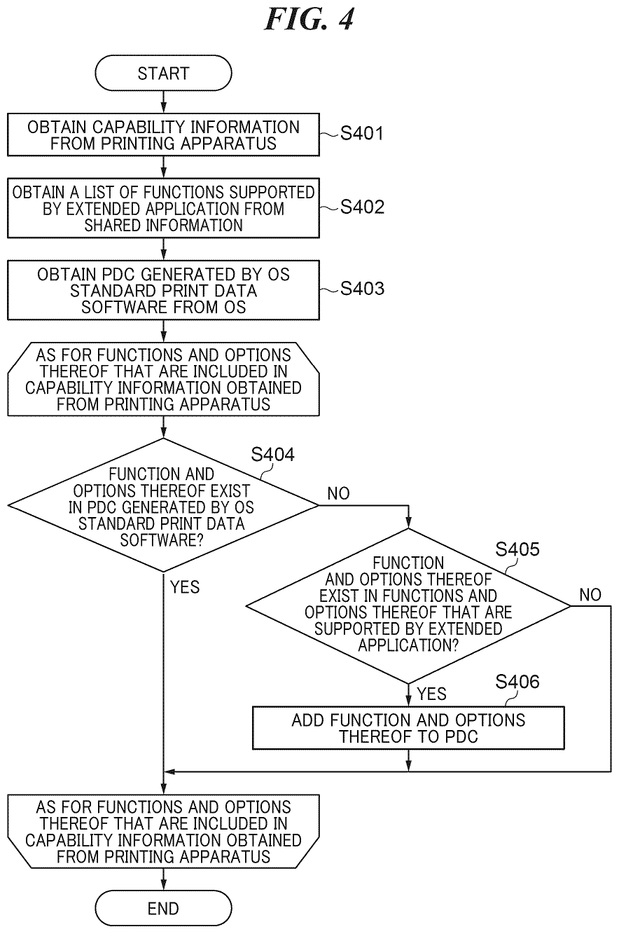

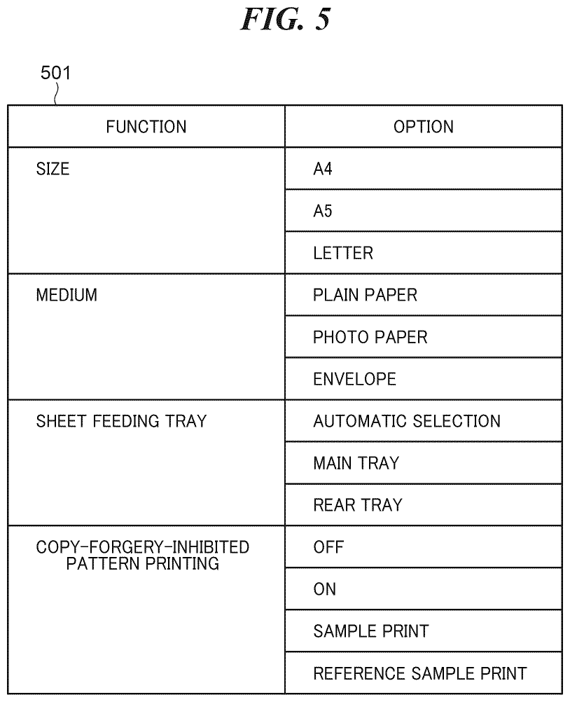

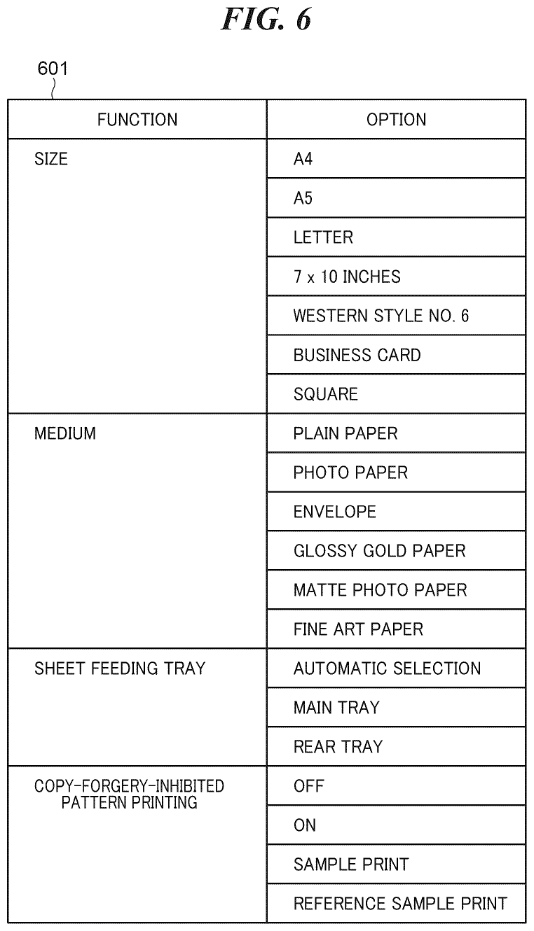

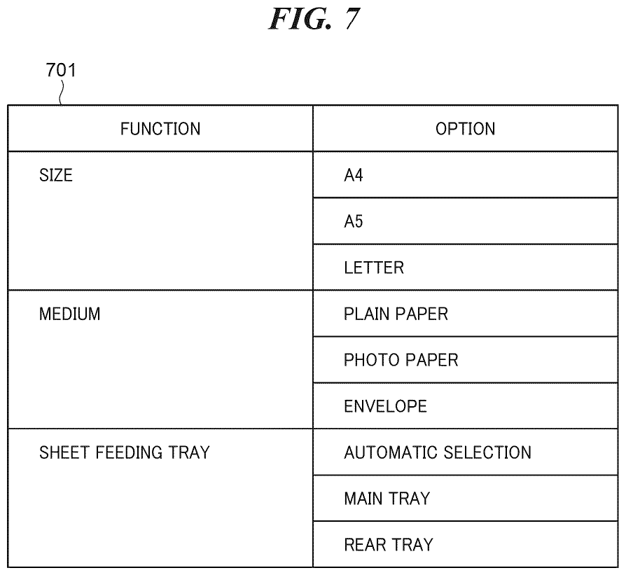

FIG. 4 is a flowchart that shows a processing in which the print function extending unit edits the print function information. It should be noted that a program based on the flowchart shown in FIG. 4 is executed by the CPU 111 controlling the print function extending unit 206. FIG. 5 is a diagram that shows an example of a list (a table) of the capability information of the printing apparatus. FIG. 6 is a diagram that shows an example of a list of the print functions supported by the extended application. FIG. 7 is a diagram that shows an example of a list (a table) of the capability information of the general purpose printing software. As shown in FIG. 4, in a step S401, the print function extending unit 206 obtains the capability information from the printing apparatus 102 (an obtaining step). The capability information is setting values included in the response obtained by issuing the IPP “Get-Printer-Attributes” operation to the printing apparatus 102. The setting values are the attribute information indicating the functions that can be designated in the printing apparatus 102, and the setting values related to the attribute information. A table 501 shown in FIG. 5 shows a list of the capability information of the printing apparatus 102. The capability information includes, for example, information about the size of the sheet to be used in printing performed by the printing apparatus 102. In addition, the capability information also includes information about the type of the sheet (the medium) to be used in printing performed by the printing apparatus 102, information about the sheet feeding tray of the sheet to be used in printing performed by the printing apparatus 102, and information about the copy-forgery-inhibited pattern printing that can be executed by the printing apparatus 102.

In a step S402, the print function extending unit 206 obtains the print functions supported by the extended application 204 from the shared information 208. A list of the print functions supported by the extended application 204 has been stored in the shared information 208. In addition, the list of the print functions supported by the extended application 204 includes all print functions that can be processed by the extended application 204 and their setting values. A table 601 shown in FIG. 6 includes, as the print function, information about the size of a sheet supported by the extended application 204. In addition, the table 601 also includes, as the print function, information about the type of the sheet (the medium) supported by the extended application 204, information about a sheet feeding tray of the sheet supported by the extended application 204, and information about the copy-forgery-inhibited pattern printing supported by the extended application 204. It should be noted that the print functions supported by the extended application 204 may be updated by, for example, updating the extended application 204.

In a step S403, the print function extending unit 206 obtains the print function information 203, which has been created by the general purpose printing software 202, from the OS. The print function information 203 is created based on the capability information 501, which has been obtained by the general purpose printing software 202 from the printing apparatus 102. The print function information 203 (the PDC) created by the general purpose printing software 202 includes only the print functions supported by the general purpose printing software 202 out of the capability information obtained from the printing apparatus 102. For example, the table 601 shown in FIG. 6 includes, as the sheet size, “7×10 inches” and “western style No. 6”, but the general purpose printing software 202 does not support the sheet size “7×10 inches” and the sheet size “western style No. 6”. Therefore, the print function information 203 does not include the sheet size “7×10 inches” and the sheet size “western style No. 6”. The print function extending unit 206 adds functions and options thereof to the print function information 203, which enables the extended application 204 to compensate for insufficient functions of the general purpose printing software 202. In addition, the print function extending unit 206 is also able to delete unnecessary functions and options thereof from the print function information 203 created by the general purpose printing software 202.

Steps S404, S405, and S406 are processes that are repeatedly performed for the list of the functions included in the capability information obtained from the printing apparatus 102 in the step S401. In the present embodiment, the steps S404, S405, and S406 are repeatedly performed for all 13 options included in the table 501.

In the step S404, the print function extending unit 206 determines whether or not the function currently being processed and options thereof exist in the print function information 203 generated by the general purpose printing software 202. As a result of the determination in the step S404, in the case of being determined that the function currently being processed and options thereof exist in the print function information 203, if the last item in the options is being processed, the processing ends. Alternatively, if the last item in the options is not being processed, the next item in the options is selected and the step S404 is executed again. On the other hand, as the result of the determination in the step S404, in the case of being determined that the function currently being processed and options thereof do not exist in the print function information 203, the processing proceeds to the step S405. For example, in the present embodiment, the table 501 includes the sheet size “A4”, and a table 701 shown in FIG. 7 also includes the sheet size “A4”. In this case, in the step S404, it is determined that the function currently being processed and options thereof exist in the print function information 203. On the other hand, the table 501 includes the copy-forgery-inhibited pattern printing “OFF”, but the table 701 does not include the copy-forgery-inhibited pattern printing “OFF”. In this case, in the step S404, it is determined that the function currently being processed and options thereof do not exist in the print function information 203.

In the step S405, the print function extending unit 206 determines whether or not the function currently being processed (and options thereof) exist in the functions (and options thereof) supported by the extended application 204. As a result of the determination in the step S405, in the case of being determined that the function currently being processed (and options thereof) exist in the functions (and options thereof) supported by the extended application 204, the processing proceeds to the step S406. On the other hand, as the result of the determination in the step S405, in the case of being determined that the function currently being processed (and options thereof) do not exist in the functions (and options thereof) supported by the extended application 204, as in the case of being determined “YES” in the step S404, if the last item in the options is being processed, the processing ends. Alternatively, if the last item in the options is not being processed, the next item in the options is selected and the step S404 is executed again. For example, in the present embodiment, in the case that the function currently being processed is the copy-forgery-inhibited pattern printing “OFF”, the copy-forgery-inhibited pattern printing “OFF” also exists in the table 601. Therefore, in the step S405, it is determined that the function currently being processed (and options thereof) exist in the functions (and options thereof) supported by the extended application 204.

In the step S406, the print function extending unit 206 adds the function currently being processed (and options thereof) to the print function information 203. After the step S406 is executed, as in the case of being determined “YES” in the step S404, if the last item in the options is being processed, the processing ends. Alternatively, if the last item in the options is not being processed, the next item in the options is selected and the step S404 is executed again.

As described above, the extended application 204 is able to add, to the print function information 203, the functions (and options thereof) that are not supported by the general purpose printing software 202, are supported by the printing apparatus 102, and are supported by the extended application 204. Then, the capability information (the PC) is generated based on the print function information 203 that has been edited by this adding process. Furthermore, the print setting screen extending unit 205 is able to generate the display screen based on this capability information, thereby extending the functions that are not supported by the general purpose printing software 202, and displaying the detailed setting screen 300C shown in FIG. 3C.

<Processes after Rendering Application Accepts Print Setting>

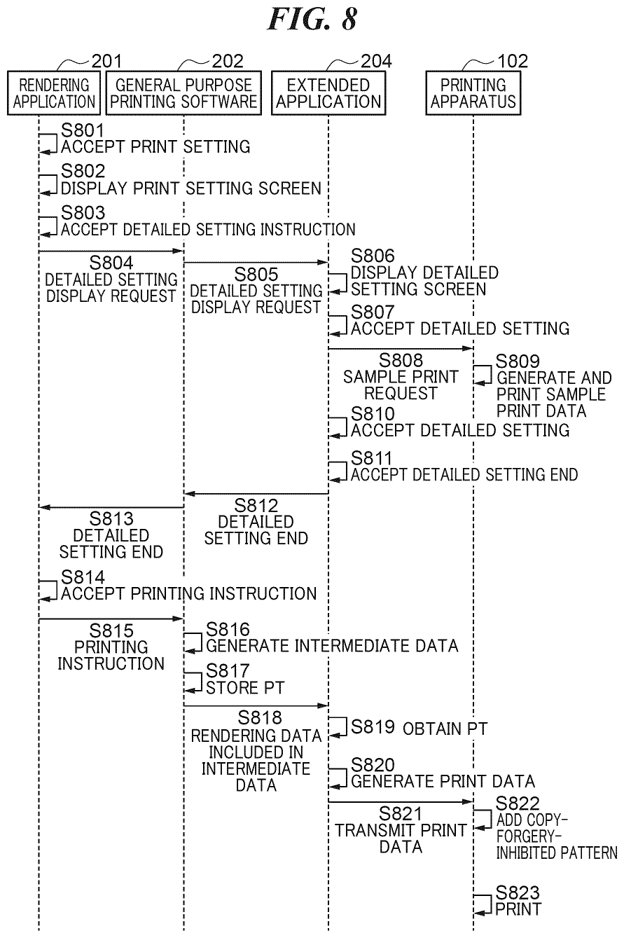

FIG. 8 is a sequence diagram that shows processes executed between the rendering application, the general purpose printing software, the extended application, and the printing apparatus after the rendering application accepts a print setting. It should be noted that here, a series of processes from performing the calibration of the copy-forgery-inhibited pattern and adjusting the density to performing the copy-forgery-inhibited pattern printing will be described. The processes in the rendering application, the general purpose printing software, and the extended application are executed by the CPU 111 of the host computer 101. This processing program has been stored in the external storage device 114. Furthermore, the CPU 111 reads the processing program from the external storage device 114 into the RAM 113 and executes it. In addition, the processes in the printing apparatus 102 are executed by the CPU (not shown) of the printing apparatus 102. Here, for ease of understanding, the case will be described in which the sample 1607 out of the reference sample 1601 and the sample 1607 is outputted. In addition, the software configuration of the printing system 1000 is the software configuration shown in FIG. 2B.

As shown in FIG. 8, in a step S801, the rendering application 201 accepts a print setting from the user. The user is able to operate, for example, the pointing device 117 or the keyboard 118 to instruct the rendering application 201 to perform the print setting.

In a step S802, the rendering application 201 displays the print setting screen 300A shown in FIG. 3A on the display unit 119.

In a step S803, the rendering application 201 accepts a detailed setting instruction from the user. The user is able to instruct to perform a detailed setting by, for example, operating the pointing device 117 or the keyboard 118 to select the control 305 on the print setting screen 300A.

In a step S804, the rendering application 201 makes a detailed setting display request with respect to the general purpose printing software 202.

In a step S805, the general purpose printing software 202 makes the detailed setting display request with respect to the extended application 204.

In a step S806, the print setting screen extending unit 205 of the extended application 204 displays the detailed setting screen 300C of FIG. 3C. As described above, the copy-forgery-inhibited pattern printing setting is added to the print function information 203 (the PDC) by the print function extending unit 206. The print setting screen extending unit 205 is able to display the detailed setting screen 300C by referring to the capability information (the PC) generated based on the print function information 203, to which the copy-forgery-inhibited pattern printing setting has been added.

In a step S807, the print setting screen extending unit 205 accepts a detailed setting made by the user on the detailed setting screen 300C. Here, as an example, it is assumed that on the detailed setting screen 300C, the sheet type “plain paper” has been selected by the control 306, the sheet size “A4” has been selected by the control 307, and the sheet feeding tray of the sheet “automatic” has been selected by the control 308 (see FIG. 3C). In this setting state, the print setting screen extending unit 205 accepts that the user has operated the control 314 on the detailed setting screen 300C. As a result, the copy-forgery-inhibited pattern calibration screen 300D shown in FIG. 3D is displayed. Here, as an example, it is assumed that on the copy-forgery-inhibited pattern calibration screen 300D, “black” has been selected from the list 317 by the control 316. In addition, it is assumed that on the copy-forgery-inhibited pattern calibration screen 300D, the density of the latent image part is adjusted as desired by the control 318, the reference value is set as desired by the control 319, and the density of the background part is finely adjusted as desired by the control 320. In this setting state, the print setting screen extending unit 205 accepts that the user has operated the control 321 on the copy-forgery-inhibited pattern calibration screen 300D.

In a step S808, the print setting screen extending unit 205 requests the printing apparatus 102 to print the sample 1607 shown in FIG. 12C. In addition, the print setting screen extending unit 205 transmits, to the printing apparatus 102, information about the various settings on the copy-forgery-inhibited pattern calibration screen 300D that have been accepted in the step S807 together with this request.

In a step S809, the printing apparatus 102 receives the above information transmitted in the step S808. The printing apparatus 102 generates and outputs data of the sample 1607 based on the above information. Here, as an example, it is assumed that the reference sample 1601 (see FIG. 12A) or the sample 1607 is outputted.

In a step S810, the print setting screen extending unit 205 accepts the optimal values that have been set by the user on the latent image part density adjustment screen 300E (see FIG. 3E) and the reference value setting screen 300F (see FIG. 3F) based on the printout outputted in the step S809.

In a step S811, the print setting screen extending unit 205 accepts the operation of the control 322 on the copy-forgery-inhibited pattern calibration screen 300D performed by the user and the operation of the control 309 on the detailed setting screen 300C performed by the user in order, and ends the detailed setting. The operation of the control 322 and the operation of the control 309 can be performed by the user operating the pointing device 117 or the keyboard 118.

In a step S812, the extended application 204 transmits, to the general purpose printing software 202, detailed setting end information indicating that the detailed setting has been ended in the step S811.

In a step S813, the general purpose printing software 202 receives the detailed setting end information transmitted from the extended application 204 in the step S812. The general purpose printing software 202 transmits this detailed setting end information to the rendering application 201.

In a step S814, the rendering application 201 accepts a printing instruction from the user. The user is able to issue the printing instruction by operating, for example, the pointing device 117 or the keyboard 118 to select the control 303 on the print setting screen 300A (see FIG. 3A).

In a step S815, the rendering application 201 issues the printing instruction accepted in the step S814 to the general purpose printing software 202.

In a step S816, the general purpose printing software 202 uses the OS module to generate intermediate data based on the printing instruction in the step S815.

In a step S817, the general purpose printing software 202 stores, in the shared information 208, the print setting information (the PT) based on the printing instruction in the step S815.

In a step S818, the general purpose printing software 202 transmits, to the extended application 204, rendering data included in the intermediate data generated in the step S816.

In a step S819, the intermediate data editing unit 207 of the extended application 204 obtains the print setting information, which has been stored in the step S817, from the shared information 208.

In a step S820, the intermediate data editing unit 207 of the extended application 204 uses the rendering data transmitted in the step S818 and the print setting information obtained in the step S819 to generate print data.

In a step S821, the intermediate data editing unit 207 of the extended application 204 transmits the print data generated in the step S820 to the printing apparatus 102.

In a step S822, the printing apparatus 102 receives the print data transmitted in the step S821. The printing apparatus 102 interprets the print data and performs a necessary image processing with respect to the print data. Here, the image processing means a processing of adding, as input data, the copy-forgery-inhibited pattern for which the density adjustment has been performed according to the settings in the step S810.

In a step S823, the printing apparatus 102 prints the print data that has been subjected to the image processing in the step S822. As a result, an image, to which the copy-forgery-inhibited pattern has been added, is outputted.

As described above, in the printing system 1000, even in the case that the general purpose printing software 202 is not able to select the copy-forgery-inhibited pattern and the calibration of the copy-forgery-inhibited pattern, using the extended application 204 makes it possible to select the copy-forgery-inhibited pattern and the calibration of the copy-forgery-inhibited pattern. In addition, the extended application 204, together with the general purpose printing software 202, is able to cause the printing apparatus 102 to execute the copy-forgery-inhibited pattern printing (the copy-forgery-inhibited pattern image data generating processing) (an executing step). As a result, a piece of printed matter, in which unauthorized copying is prevented by the copy-forgery-inhibited pattern, will be printed by the printing apparatus 102. It should be noted that in the description with reference to FIG. 8, the software configuration of the printing system 1000 is the software configuration shown in FIG. 2B and the detailed setting screen 300C shown in FIG. 3C is displayed, but the present invention is not limited to this. For example, in the case that the detailed setting display request is made with respect to the general purpose printing software 202 in the step S804, the general purpose printing software 202 displays the detailed setting screen 300B shown in FIG. 3B.

In this case, after the control 309 on the detailed setting screen 300B is operated, the general purpose printing software 202 requests the extended application 204 to display an additional detailed setting screen. Next, the extended application 204 may cause to additionally display a detailed setting screen on which setting of the copy-forgery-inhibited pattern and setting of the calibration of the copy-forgery-inhibited pattern can be performed. In addition, in the present embodiment, the extended application 204 generates the print data from the intermediate data generated by the general purpose printing software 202, but the present invention is not limited to this, for example, the extended application 204 itself may generate the intermediate data.

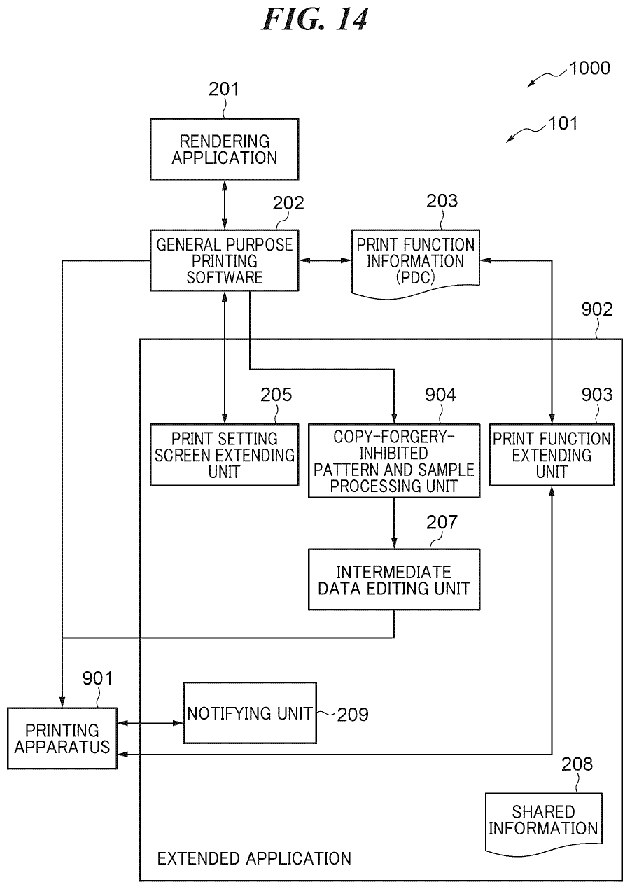

Hereinafter, a second embodiment will be described with reference to FIGS. 14 to 17B. The differences from the first embodiment described above will be mainly described, and descriptions of similar matters will be omitted. In the first embodiment, the extended application 204, together with the general purpose printing software 202, generates the print data including the setting for the copy-forgery-inhibited pattern and the setting for the calibration of the copy-forgery-inhibited pattern. That is, the extended application 204, together with the general purpose printing software 202, generates the print data including the setting for the copy-forgery-inhibited pattern and the setting for the calibration of the copy-forgery-inhibited pattern. This print data is transmitted to the printing apparatus 102. The printing apparatus 102 interprets the print data including the setting for the copy-forgery-inhibited pattern and the setting for the calibration of the copy-forgery-inhibited pattern, and generates and outputs sample print data for the composition of the copy-forgery-inhibited pattern and the calibration of the copy-forgery-inhibited pattern. As described above, in the first embodiment, the extended application 204, together with the general purpose printing software 202, causes the printing apparatus 102 to execute the image data generating processing that generates the image data of the copy-forgery-inhibited pattern.

However, depending on the printing apparatus 102, there may be a case where the printing apparatus 102 does not include a generating unit that generates a sample for the copy-forgery-inhibited pattern and the calibration of the copy-forgery-inhibited pattern (hereinafter, referred to as “a copy-forgery-inhibited pattern and sample generating unit”), that is, there may be a case where the printing apparatus 102 is not able to execute the copy-forgery-inhibited pattern image data generating processing. In this case, it is preferable to generate the print data after performing the generation of the sample print data for the composition of the copy-forgery-inhibited pattern and the calibration of the copy-forgery-inhibited pattern, and then transmit the print data to the printing apparatus 102. Therefore, in the second embodiment, based on the capability information of the printing apparatus 102, determining whether or not the printing apparatus 102 includes the copy-forgery-inhibited pattern and sample generating unit. As a result of the determination, in the case of being determined that the printing apparatus 102 includes the copy-forgery-inhibited pattern and sample generating unit, the extended application 204 generates the print data reflecting the setting for the copy-forgery-inhibited pattern and the setting for the calibration of the copy-forgery-inhibited pattern, and transmits the print data to the printing apparatus 102. On the other hand, in the case of being determined that the printing apparatus 102 does not include the copy-forgery-inhibited pattern and sample generating unit, the extended application 204 performs the generation of the sample print data for the composition of the copy-forgery-inhibited pattern and the calibration of the copy-forgery-inhibited pattern with respect to the rendering data to generate the print data, and transmits the print data to the printing apparatus 102. As a result, even in the case that the printing apparatus 102 does not include the copy-forgery-inhibited pattern and sample generating unit, it is possible to provide the user with the copy-forgery-inhibited pattern and the calibration function of the copy-forgery-inhibited pattern. It should be noted that the second embodiment is similar to the first embodiment described above, except for the configuration of the printing system 1000 in the case that the extended application 204 has been associated, the editing processing of the PDC, and the processes after the rendering application 201 accepts the print setting.

### <Configuration of Printing System Centered on Software>

FIG. 14 is a block diagram that shows a software configuration of a printing system according to the second embodiment. The block diagram shown in FIG. 14 is a diagram that shows a configuration in the case that an extended application 902 has been associated with the general purpose printing software 202 and a printing apparatus 901. As shown in FIG. 14, the host computer 101 includes the rendering application 201, the general purpose printing software 202, the print function information 203, and the extended application 902. In addition, the extended application 902 is communicably connected to the printing apparatus 901. The printing apparatus 901 is different from the printing apparatus 102 in the first embodiment, and is a printing apparatus that does not include the copy-forgery-inhibited pattern and sample generating unit. The extended application 902 includes the print setting screen extending unit 205, the intermediate data editing unit 207, the notifying unit 209, a print function extending unit 903, and a copy-forgery-inhibited pattern and sample processing unit 904. Even in the case of being determined based on capability information obtained from the printing apparatus 901 that the printing apparatus 901 does not include the copy-forgery-inhibited pattern and the calibration function of the copy-forgery-inhibited pattern, the print function extending unit 903 performs the generation of the sample for the copy-forgery-inhibited pattern and the calibration of the copy-forgery-inhibited pattern in the extended application 902. The copy-forgery-inhibited pattern and the calibration function of the copy-forgery-inhibited pattern are added to the print function information 203. The copy-forgery-inhibited pattern and sample processing unit 904 performs the composition of the copy-forgery-inhibited pattern and the calibration of the copy-forgery-inhibited pattern with respect to intermediate data (rendering data) from the general purpose printing software 202 based on the setting for the copy-forgery-inhibited pattern and the calibration setting of the copy-forgery-inhibited pattern.

<Flowchart of Print Function Extending Unit that Edits Print Function Information>

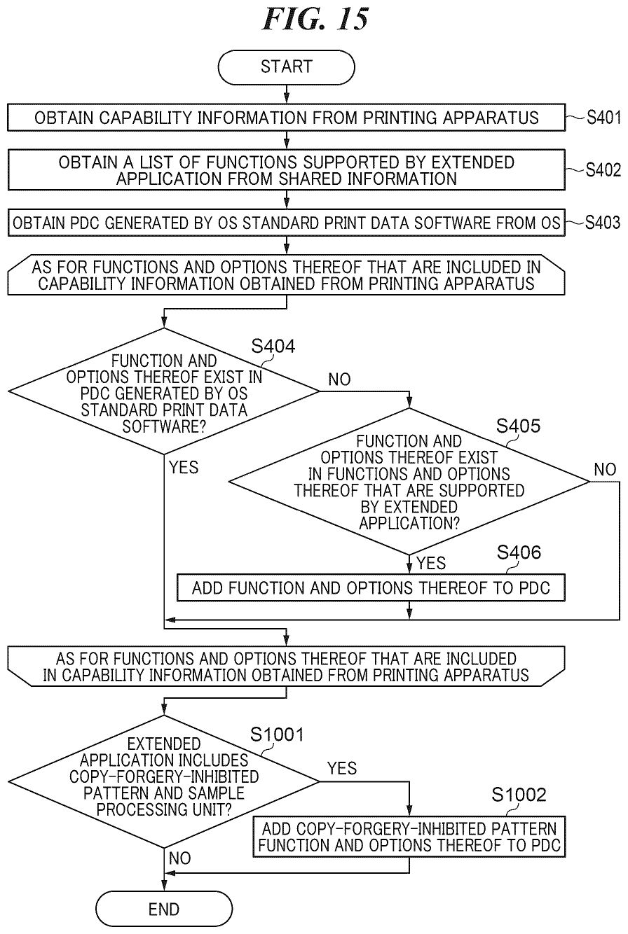

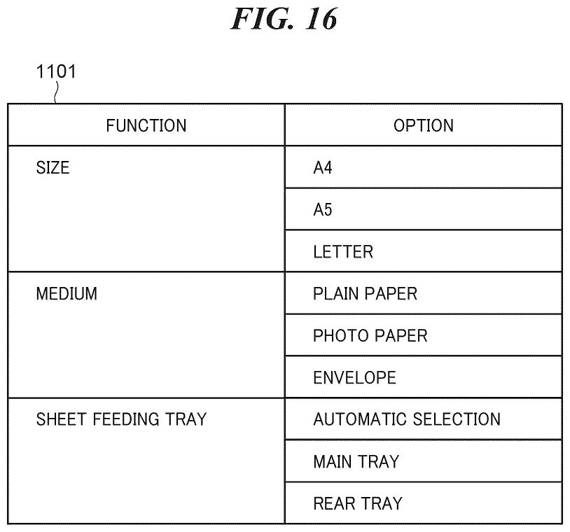

FIG. 15 is a flowchart that shows a processing in which the print function extending unit edits the print function information. It should be noted that a program based on the flowchart shown in FIG. 15 is executed by the CPU 111 controlling the print function extending unit 903. In addition, the flowchart shown in FIG. 15 is a flowchart in which steps S1001 and S1002 are added to the flowchart shown in FIG. 4. FIG. 16 is a diagram that shows an example of a list (a table) of the capability information of the printing apparatus.

As shown in FIG. 15, in the case that the repeated processing of the steps S404, S405, and S406 is completed, the processing proceeds to the step S1001. A table 1101 shown in FIG. 16 shows a list of the capability information of the printing apparatus 901. This table 1101 includes, as the capability information, information about the size of the sheet, information about the type of the sheet, and information about the sheet feeding tray of the sheet, but unlike the table 501 shown in FIG. 5, the table 1101 does not include information about the copy-forgery-inhibited pattern printing. Therefore, it is understood that the printing apparatus 901 does not include the copy-forgery-inhibited pattern and sample generating unit. Therefore, the copy-forgery-inhibited pattern and the calibration function of the copy-forgery-inhibited pattern are not added to the print function information 203 after the processes of the steps S404, S405, and S406 are completed.

In the step S1001, the print function extending unit 903 determines whether or not the extended application 902 includes the copy-forgery-inhibited pattern and sample processing unit 904, that is, whether or not the copy-forgery-inhibited pattern and sample processing unit 904 exists in the extended application 902. As a result of the determination in the step S1001, in the case of being determined that the extended application 902 includes the copy-forgery-inhibited pattern and sample processing unit 904, the processing proceeds to the step S1002. On the other hand, as the result of the determination in the step S1001, in the case of being determined that the extended application 902 does not include the copy-forgery-inhibited pattern and sample processing unit 904, the processing ends. As described above, since the extended application 902 includes the copy-forgery-inhibited pattern and sample processing unit 904, the processing proceeds to the step S1002.

In the step S1002, the print function extending unit 903 adds, to the print function information 203, information about the copy-forgery-inhibited pattern printing supported by the extended application 902 in the table 601 shown in FIG. 6 (options: OFF, ON, sample print, reference sample print).

As described above, the extended application 902 is able to add, to the print function information 203, the functions (and options thereof) that are not supported by the general purpose printing software 202, are supported by the printing apparatus 901, and are supported by the extended application 204. Then, the extended application 902 determines whether or not the copy-forgery-inhibited pattern and sample processing unit 904 exists. As a result of the determination, in the case of being determined that the copy-forgery-inhibited pattern and sample processing unit 904 exists, the copy-forgery-inhibited pattern and the calibration function of the copy-forgery-inhibited pattern are added to the print function information 203. By this adding process, even in the case that the printing apparatus 901 does not include the copy-forgery-inhibited pattern and sample generating unit, the capability information is generated based on the print function information 203, to which the copy-forgery-inhibited pattern and the calibration function of the copy-forgery-inhibited pattern have been added. The extended application 902 is able to display the detailed setting screen 300C shown in FIG. 3C by generating a display screen based on this capability information.

<Processes after Rendering Application Accepts Print Setting>

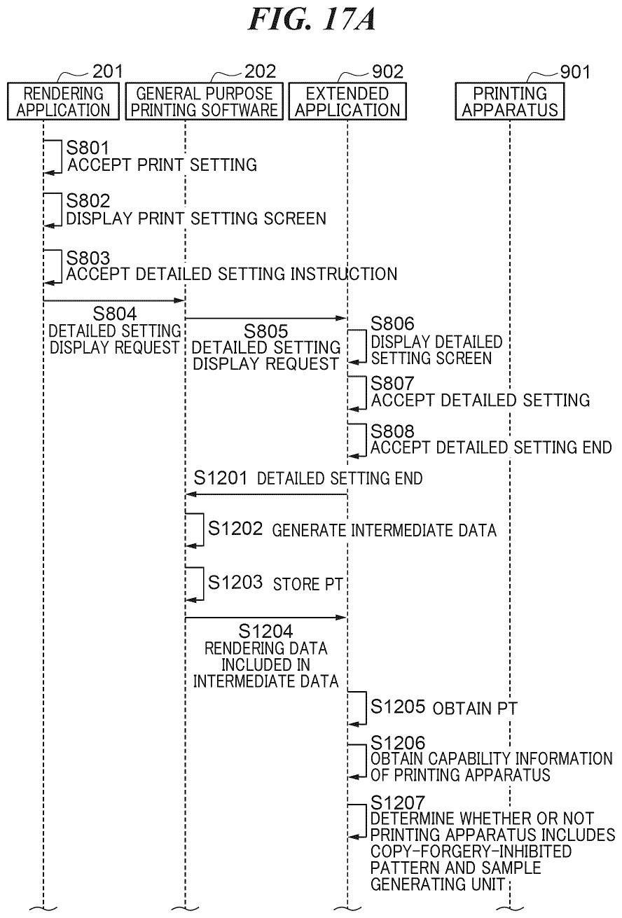

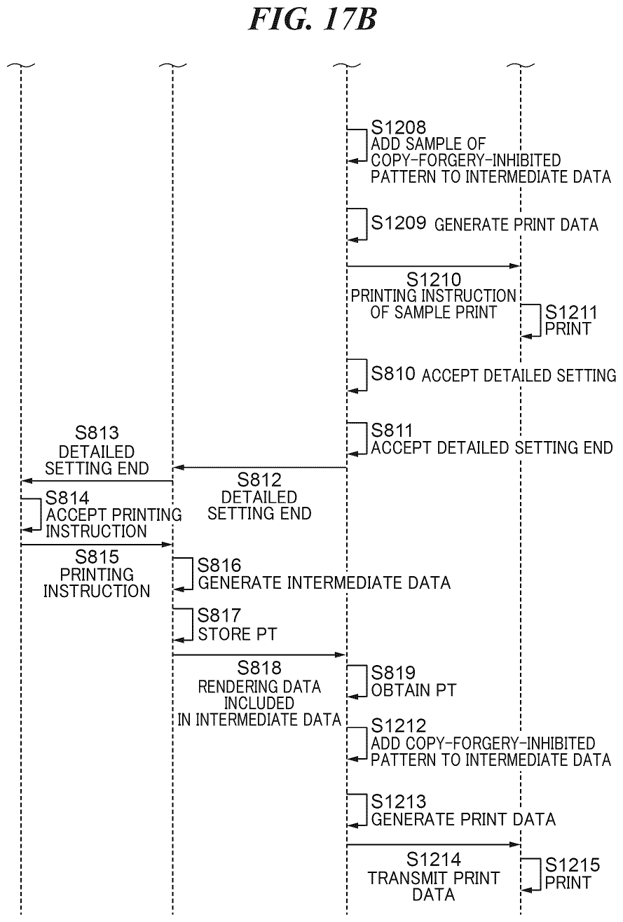

FIG. 17A and FIG. 17B are diagrams showing a sequence diagram that shows processes executed between the rendering application, the general purpose printing software, the extended application, and the printing apparatus after the rendering application accepts a print setting. The sequence diagram shown in FIG. 17A and FIG. 17B is a sequence diagram in which steps S1201 to S1215 are mainly added to the sequence diagram shown in FIG. 8. As shown in FIG. 17A, in the step S808 after the step S807 is executed, the print setting screen extending unit 205 accepts the end of the detailed setting in the step S807.

Then, after the step S808 is executed, the processing proceeds to the step S1201. In the step S1201, the copy-forgery-inhibited pattern and sample processing unit 904 of the extended application 902 transmits, to the general purpose printing software 202, detailed setting end information indicating that the detailed setting has been ended in the step S808. It should be noted that the detailed setting end information includes setting information set by the controls 316, 318, 319, 320, and 321 on the copy-forgery-inhibited pattern calibration screen 300D.

In the step S1202, the general purpose printing software 202 uses the OS module to generate intermediate data. For example, the general purpose printing software 202 generates a blank image as the rendering data, and generates the settings notified in the step S1201 as the intermediate data.

In the step S1203, the general purpose printing software 202 stores the print setting information (the PT) in the shared information 208.

In the step S1204, the general purpose printing software 202 transmits, to the extended application 902, the rendering data included in the intermediate data generated in the step S1202.

In the step S1205, the copy-forgery-inhibited pattern and sample processing unit 904 of the extended application 902 obtains the print setting information, which has been stored in the step S1203, from the shared information 208. In addition, the copy-forgery-inhibited pattern and sample processing unit 904 obtains the setting information set by the respective controls, which is included in the detailed setting end information transmitted in the step S1201.

In the step S1206, the copy-forgery-inhibited pattern and sample processing unit 904 obtains the capability information of the printing apparatus 901 from the shared information 208. It should be noted that in the case that the shared information 208 does not include the capability information of the printing apparatus 901, the print function extending unit 903 may request the capability information to the printing apparatus 901. Also in this case, the capability information is stored in the shared information 208.

In the step S1207, the copy-forgery-inhibited pattern and sample processing unit 904 determines based on the capability information obtained in the step S1206 whether or not the printing apparatus 901 includes the copy-forgery-inhibited pattern and sample generating unit. As described above, in the second embodiment, the printing apparatus 901 does not include the copy-forgery-inhibited pattern and sample generating unit. Therefore, as a result of the determination in the step S1207, it is determined that the printing apparatus 901 does not include the copy-forgery-inhibited pattern and sample generating unit. It should be noted that as the result of the determination in the step S1207, in the case of being determined that the printing apparatus 901 includes the copy-forgery-inhibited pattern and sample generating unit, the processing skips (omits) the step S1208 and proceeds to the step S1209. This is because the copy-forgery-inhibited pattern and sample generating unit within the printing apparatus 901 is able to generate the sample faster than the copy-forgery-inhibited pattern and sample processing unit 904 by using an application specific integrated circuit (an ASIC).

In the step S1208, the copy-forgery-inhibited pattern and sample processing unit 904 adds the sample of the copy-forgery-inhibited pattern to the rendering data based on the setting information of the calibration of the copy-forgery-inhibited pattern, which is included in the print setting information obtained in the step S1205. This added information is stored in the shared information 208. In addition, the copy-forgery-inhibited pattern and sample processing unit 904 edits the setting value of the calibration of the copy-forgery-inhibited pattern in the print setting information to “0”, or deletes the setting information of the calibration of the copy-forgery-inhibited pattern from the print setting information.

In the step S1209, the intermediate data editing unit 207 of the extended application 902 generates the print data by using the rendering data transmitted in the step S1204 and the print setting information obtained in the step S1205.

In the step S1210, the intermediate data editing unit 207 of the extended application 902 transmits the print data generated in the step S1209 to the printing apparatus 901.

In the step S1211, the printing apparatus 901 receives the print data transmitted in the step S1210. The printing apparatus 901 interprets the print data, performs a necessary image processing with respect to the print data, and executes printing. Then, after the step S1211 is executed, the processing proceeds to the steps S810 to S819 in order.

Then, after the step S819 is executed, the processing proceeds to the step 1212. In the step S1212, the copy-forgery-inhibited pattern and sample processing unit 904 of the extended application 902 adds the copy-forgery-inhibited pattern to the rendering data based on the setting information of the calibration of the copy-forgery-inhibited pattern, which is included in the print setting information obtained in the step S1205. This added information is stored in the shared information 208. In addition, the copy-forgery-inhibited pattern and sample processing unit 904 edits the setting value of the copy-forgery-inhibited pattern in the print setting information to “0”, or deletes the setting information of the copy-forgery-inhibited pattern from the print setting information.

In the step S1213, the intermediate data editing unit 207 of the extended application 902 generates the print data by using the rendering data stored in the shared information 208 and the print setting information. It should be noted that in the step S1213, a preview of the print data may be performed.

In the step S1214, the intermediate data editing unit 207 of the extended application 902 transmits the print data generated in the step S1213 to the printing apparatus 901.

In the step S1215, the printing apparatus 901 receives the print data transmitted in the step S1214. The printing apparatus 901 interprets the print data, performs a necessary image processing with respect to the print data, and executes printing.

As described above, in the second embodiment, even in the case that the printing apparatus 901 does not include the copy-forgery-inhibited pattern and sample generating unit, instead of the copy-forgery-inhibited pattern and sample generating unit, the extended application 902 is able to execute the copy-forgery-inhibited pattern image data generating processing together with the general purpose printing software 202. As a result, the printing apparatus 901 is also able to print a piece of printed matter, in which unauthorized copying is prevented by the copy-forgery-inhibited pattern. In this way, in the second embodiment, in the case of being determined that the printing apparatus 901 does not include the copy-forgery-inhibited pattern and sample generating unit, the extended application 902 is able to execute the copy-forgery-inhibited pattern image data generating processing together with the general purpose printing software 202. On the other hand, in the case of being determined that the printing apparatus 901 includes the copy-forgery-inhibited pattern and sample generating unit, similar to the first embodiment described above, the extended application 902, together with the general purpose printing software 202, is also able to cause the printing apparatus 901 to execute the copy-forgery-inhibited pattern image data generating processing.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-132028, filed on Aug. 14, 2023, which is hereby incorporated by reference herein in its entirety.

What is claimed is:

1. A non-transitory computer-readable storage medium storing an application program, the application program causing a computer of an information processing apparatus to:
support software capable of generating print data printable by printing apparatuses of a plurality of manufacturers, and causing the information processing apparatus to transmit the print data to the printing apparatuses of the plurality of manufacturers; and
cause the printing apparatus to execute an image data generating processing that generates image data of a copy-forgery-inhibited pattern image that comes up when a piece of printed matter is copied, the image data being assigned to the piece of printed matter printed based on print data generated by the software.

2. The non-transitory computer-readable storage medium according to claim 1, wherein
the application program further causes the computer of the information processing apparatus to:
obtain capability information of the printing apparatus from the printing apparatus;
determine, based on the obtained capability information, whether or not the printing apparatus is capable of executing the image data generating processing;
cause, as a result of the determination, in a case of being determined that the printing apparatus is capable of executing the image data generating processing, the printing apparatus to execute the image data generating processing; and
execute, in a case of being determined that the printing apparatus is not capable of executing the image data generating processing, the image data generating processing.

3. A non-transitory computer-readable storage medium storing an application program, the application program causing a computer of an information processing apparatus to:
support software capable of generating print data printable by printing apparatuses of a plurality of manufacturers, and causing the information processing apparatus to transmit the print data to the printing apparatuses of the plurality of manufacturers; and
execute an image data generating processing that generates image data of a copy-forgery-inhibited pattern image that comes up when a piece of printed matter is copied, the image data being assigned to the piece of printed matter printed based on print data generated by the software.

4. The non-transitory computer-readable storage medium according to claim 1, wherein
the application program further causes the computer of the information processing apparatus to:
set execution conditions when executing the image data generating processing; and
convert, based on the execution conditions that have been set, intermediate data generated by the software into the print data capable of printing the copy-forgery-inhibited pattern image by the printing apparatus.

5. The non-transitory computer-readable storage medium according to claim 4, wherein
the application program further causes the computer of the information processing apparatus to:
cause a display unit to display a setting screen on which the execution conditions are settable.

6. The non-transitory computer-readable storage medium according to claim 5, wherein
the copy-forgery-inhibited pattern image has a background part that disappears after copying and a latent image part that remains after copying, and
the setting screen includes, as the execution conditions, at least one of a selecting section that selects whether or not to execute the image data generating processing, a color determining section that determines a color of the copy-forgery-inhibited pattern image, a density adjusting section that adjusts a density of the background part, and a density adjusting section that adjusts a density of the latent image part.

7. The non-transitory computer-readable storage medium according to claim 4, wherein
the application program further causes the computer of the information processing apparatus to:
cause a display unit to display an information screen including information about the copy-forgery-inhibited pattern image.

8. The non-transitory computer-readable storage medium according to claim 7, wherein
the information screen includes, as the information about the copy-forgery-inhibited pattern image, at least one of a print instructing section that instructs printing of a sample of the copy-forgery-inhibited pattern image, and a sample image of the copy-forgery-inhibited pattern image.

9. The non-transitory computer-readable storage medium according to claim 1, wherein
software that is not capable of executing the image data generating processing is used as the software.

10. The non-transitory computer-readable storage medium according to claim 1, wherein
software that runs based on the internet printing protocol (IPP) is used as the software.

11. A control method for an information processing apparatus comprising:
supporting software capable of generating print data printable by printing apparatuses of a plurality of manufacturers, and causing the information processing apparatus to transmit the print data to the printing apparatuses of the plurality of manufacturers; and
causing the printing apparatus to execute an image data generating processing that generates image data of a copy-forgery-inhibited pattern image that comes up after a piece of printed matter is copied, the image data being assigned to the piece of printed matter printed based on print data generated by the software.

12. An information processing apparatus comprising:
an application that supports software capable of generating print data printable by printing apparatuses of a plurality of manufacturers, and causing the information processing apparatus to transmit the print data to the printing apparatuses of the plurality of manufacturers, and
wherein the application causes the printing apparatus to execute an image data generating processing that generates image data of a copy-forgery-inhibited pattern image that comes up after a piece of printed matter is copied, the image data being assigned to the piece of printed matter printed based on print data generated by the software.
